(19) United States
(12) Patent Application Publication
(10) Pub. No.: US 2025/0287266 A1
(43) Pub. Date: Sep. 11, 2025

(54) TERMINAL AND COMMUNICATION METHOD

(71) Applicant: NTT DOCOMO, INC., Tokyo (JP)

(72) Inventors: Shohei Yoshioka, Chiyoda-ku, Tokyo (JP); Naoya Shibaike, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 18/856,327

(22) PCT Filed: Apr. 19, 2022
(86) PCT No.: PCT/JP2022/018233

§ 371 Date: Oct. 11, 2024

(51) Int. Cl. H04W 28/26; H04W 72/02; H04W 92/18

(52) U.S. Cl. CPC H04W 28/26; H04W 72/02; H04W 92/18

(57) ABSTRACT

A terminal includes a communication unit configured to perform transmission and reception of a first Radio Access Technology (RAT), and a control unit configured to control communication of the first RAT, wherein the communication unit receives information related to resource reservation of a second RAT from an other terminal, the control unit performs at least one of an operation of determining a resource set of the first RAT available in a physical layer and an operation of selecting a resource from the resource set in a Medium Access Control (MAC) layer, based on the information related to the resource reservation, and the communication unit performs a transmission to the other terminal using the selected resource.

### TECHNICAL FIELD

The present invention relates to terminals and communication methods in wireless communication systems.

### BACKGROUND ART

In Long Term Evolution (LTE) and successor systems to the LTE (for example, LTE Advanced (LTE-A), New Radio (NR) (also referred to as 5G)), a Device to Device (D2D)) technology in which terminals directly communicate with each other without using a base station is being studied (for example, Non-Patent Document 1).

The D2D reduces traffic between the terminal and the base station, and enables communication between the terminals even when the base station is unable to communicate due to a disaster and the like. Although 3rd Generation Partnership Project (3GPP) refers to the D2D as “sidelink”, the D2D, which is a more generally used term, will be used in the present specification. However, in the following description of embodiments, the sidelink is also used, as required.

The D2D communication can be broadly categorized into D2D discovery for discovering other terminals able to communicate, and D2D communication (also referred to as D2D direct communication, inter-terminal direct communication, and the like) for making direct communication between the terminals. Hereinafter, when not particularly distinguishing the D2D communication, the D2D discovery, and the like, the D2D communications are simply referred to as D2D. A signal transmitted and received by the D2D is referred to as a D2D signal. Various use cases of services associated with Vehicle to Everything (V2X) of the NR are being studied (for example, Non-Patent Document 2).

### PRIOR ART DOCUMENTS

### Non-Patent Documents

Non-Patent Document 1: 3GPP TS 38.211 V16. 8.0 (2021-12)

Non-Patent Document 2: 3GPP TR 22.886 V15. 1.0 (2017-03)

Non-Patent Document 3: 3GPP TS 38.214 V16. 8.0 (2021-12)

Non-Patent Document 4: 3GPP TS 38.213 V16. 8.0 (2021-12)

Non-Patent Document 5: 3GPP TS 36.213 V16. 8.0 (2021-12)

### DISCLOSURE OF THE INVENTION

### Problem To Be Solved By The Invention For example, the sidelink of a certain Radio

Access Technology (RAT) supports a transmission mode in which the terminals autonomously determine a resource to be used for the transmission. In addition, the transmission mode in which the terminals autonomously determine the resource to be used for the transmission is also supported in the sidelink of an other RAT. In this transmission mode, the terminals detect future resource use by decoding signals of each other and operate so as not to generate a collision. However, the sidelink of the certain RAT and the sidelink of the other RAT are defined as different signals, and it is not possible to detect each other and avoid the collision. For this reason, it is difficult for the sidelink of the certain RAT and the sidelink of the other RAT to share resources.

The present invention has been conceived in view of the above, and one object of the present invention is to share resources between D2D direct communications using different Radio Access Technologies (RATs).

### Means for Solving the Problem

According to the disclosed technique, there is provided a terminal including a communication unit configured to perform transmission and reception of a first Radio Access Technology (RAT), and a control unit configured to control communication of the first RAT, wherein the communication unit receives information related to resource reservation of a second RAT from an other terminal, the control unit performs at least one of an operation of determining a resource set of the first RAT available in a physical layer and an operation of selecting a resource from the resource set in a Medium Access Control (MAC) layer, based on the information related to the resource reservation, and the communication unit performs a transmission to the other terminal using the selected resource.

### Effects Of The Invention

According to the disclosed technique, resources can be shared between the D2D direct communications using different Radio Access Technologies (RATs).

### BRIEF DESCRIPTION OF THE DRAWINGS

FIG. 1 is a diagram for explaining a V2X.

FIG. 2 is a diagram for explaining an example (1) of a transmission mode of the V2X.

FIG. 3 is a diagram for explaining an example (2) of the transmission mode of the V2X.

FIG. 4 is a diagram for explaining an example (3) of the transmission mode of the V2X.

FIG. 5 is a diagram for explaining an example (4) of the transmission mode of the V2X.

FIG. 6 is a diagram for explaining an example (5) of the transmission mode of the V2X.

FIG. 7 is a diagram for explaining an example (1) of a communication type of the V2X.

FIG. 8 is a diagram for explaining an example (2) of the communication type of the V2X.

FIG. 9 is a diagram for explaining an example (3) of the communication type of the V2X.

FIG. 10 is a sequence diagram illustrating an operation example (1) of the V2X.

FIG. 11 is a sequence diagram illustrating an operation example (2) of the V2X.

FIG. 12 is a sequence diagram illustrating an operation example (3) of the V2X.

FIG. 13 is a sequence diagram illustrating an operation example (4) of the V2X.

FIG. 14 is a diagram illustrating an example of a sensing operation.

FIG. 15 is a flow chart for explaining an example of a preemption operation.

FIG. 16 is a diagram illustrating the example of the preemption operation.

FIG. 17 is a diagram illustrating an example of a partial sensing operation.

FIG. 18 is a diagram for explaining an example of a periodic-based partial sensing.

FIG. 19 is a diagram for explaining an example of a contiguous partial sensing.

FIG. 20 is a diagram for explaining an example (1) of a communication state.

FIG. 21 is a diagram for explaining an example (2) of the communication state.

FIG. 22 is a diagram for explaining an example (3) of the communication state.

FIG. 23 is a diagram for explaining an example (4) of the communication state.

FIG. 24 is a diagram for explaining an example (5) of the communication state.

FIG. 25 is a sequence diagram for explaining an example of an inter-UE coordination.

FIG. 26 is a diagram for explaining examples of a NR-SL and a LTE-SL.

FIG. 27 illustrates an example of information sharing in an embodiment of the present invention.

FIG. 28 is a diagram illustrating an example (1) of a resource exclusion in the embodiment of the present invention.

FIG. 29 is a diagram illustrating an example (2) of the resource exclusion in the embodiment of the present invention.

FIG. 30 is a diagram illustrating an example of a functional configuration of a base station 10 according to the embodiment of the present invention.

FIG. 31 is a diagram illustrating an example of a functional configuration of a terminal 20 according to the embodiment of the present invention.

FIG. 32 is a diagram illustrating an example of a hardware configuration of the base station 10 or the terminal 20 according to the embodiment of the present invention.

FIG. 33 is a diagram illustrating an example of a configuration of a vehicle 2001 according to the embodiment of the present invention.

### MODE OF CARRYING OUT THE INVENTION

Hereinafter, embodiments of the present invention will be described with reference to the drawings. The embodiments described below are examples, and the embodiments to which the present invention can be applied are not limited to the following embodiments.

During operation of a wireless communication system according to an embodiment of the present invention, an existing technology is used, as appropriate. The existing technology is the existing LTE, for example, but the existing technology is not limited to the existing LTE. In addition, the term “LTE” used in the present specification has a broad meaning including LTE-Advanced, successor systems to the LTE-Advanced (for example, NR), and a wireless Local Area Network (LAN), unless indicated otherwise.

Moreover, in an embodiment of the present invention, a duplex system may be a Time Division Duplex (TDD) system, a Frequency Division Duplex (FDD) system, or other systems (for example, Flexible Duplex, and the like).

Further, in an embodiment of the present invention, “to configure” a radio parameter and the like may refer to pre-configuring the radio parameter to a predetermined value, or refer to configuring the radio parameter to a radio parameter indicated from the base station 10 or the terminal 20.

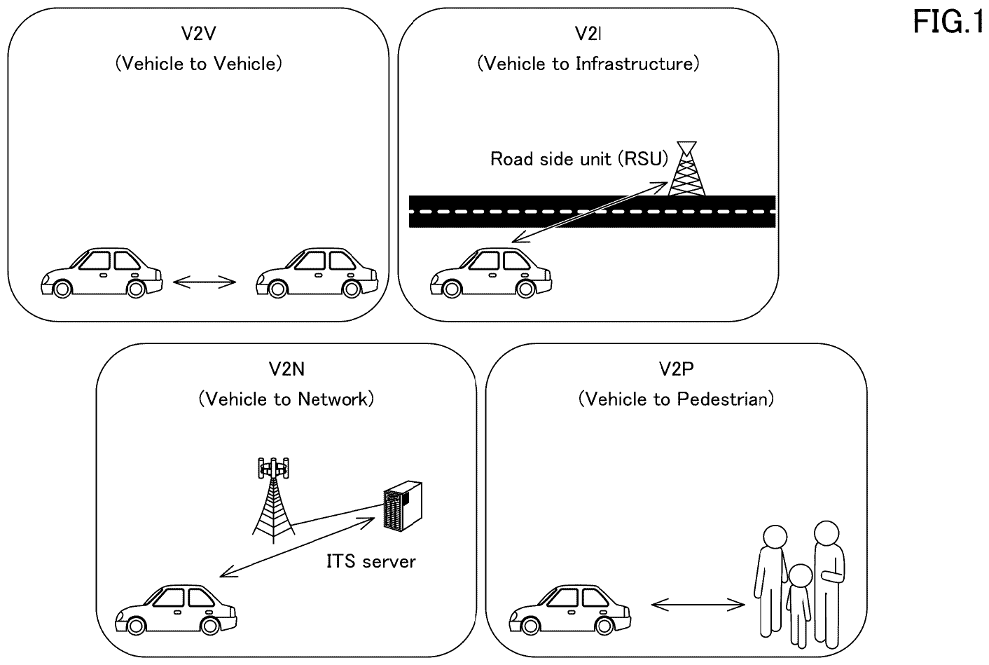

FIG. 1 is a diagram for explaining a V2X. In 3GPP, studies are being made to achieve Vehicle to Everything (V2X) or enhanced V2X (eV2X) by extending D2D functions, and advance standardization. As illustrated in FIG. 1, V2X is a part of Intelligent Transport Systems (ITS), and is a general term for Vehicle to Vehicle (V2V) which refers to a communication method performed between vehicles, Vehicle to Infrastructure (V2I) which refers to a communication method performed between a vehicle and a Road-Side Unit (RSU) installed on a road-side, Vehicle to Network (V2N) which refers to a communication method performed between a vehicle and an ITS server, and Vehicle to Pedestrian (V2P) which refers to a communication method performed between a vehicle and a mobile terminal carried by a pedestrian.

Further, in 3GPP, V2X using cellular communication of LTE or NR and terminal to terminal communication is being studied. The V2X using the cellular communication is also referred to as a cellular V2X. In the V2X using the cellular communication of NR, studies are being made to achieve a high capacity, a low delay, a high reliability, and Quality of Service (QOS) control.

It may be assumed that the V2X of the LTE or the NR will be studied in the future without limiting to the 3GPP specifications. For example, it may be assumed that methods of ensuring interoperability, reducing costs by implementing a higher layer, combined use or switching of a plurality of Radio Access Technologies (RATs), and complying with regulations in each country, and methods of acquiring and distributing data on a V2X platform of the LTE or the NR, and managing and utilizing a database, will be studied.

In the embodiments of the present invention, a form in which the communication device is installed in a vehicle will mainly be assumed, but the embodiments of the present invention are not limited to such a configuration. For example, the communication device may be a terminal held by a person, the communication device may be a device installed on a drone or an aircraft, and the communication device may be a base station, an RSU, a relay station (relay node), a terminal having a scheduling capability, and the like.

The Sidelink (SL) may be distinguished from the Uplink (UL) or the Downlink (DL) based on any one or a combination of the following 1) through 4). In addition, the SL may be referred to by another name.
1) Resource allocation in time domain;
2) Resource allocation in frequency domain;
3) Synchronization signal to be referred to (including Sidelink Synchronization Signal (SLSS)); and
4) Reference signal used for path loss measurement for transmission power control.

In addition, with respect to Orthogonal Frequency Division Multiplexing (OFDM) of the SL or the UL, any one of Cyclic-Prefix OFDM (CP-OFDM), Discrete Fourier Transform-Spread-OFDM (DFT-S-OFDM), OFDM not subjected to transform precoding, and OFDM that is subjected to transform precoding, may be applied.

In the SL of the LTE, Mode3 and Mode4 are prescribed for a resource allocation of the SL to the terminal 20. In the Mode3, a transmission resource is dynamically allocated by a Downlink Control Information (DCI) transmitted from the base station 10 to the terminal 20. Moreover, in the Mode3, Semi Persistent Scheduling (SPS) is also possible. In the Mode4, the terminal 20 autonomously selects a transmission resource from a resource pool.

A slot in the embodiments of the present invention may be replaced with a symbol, a mini slot, a sub frame, a radio frame, or a Transmission Time Interval (TTI). Further, the cell in the embodiments of the present invention may be replaced with a cell group, a carrier component, a BWP, a resource pool, a resource, a Radio Access Technology (RAT), a system (including a wireless LAN), and the like.

In the embodiments of the present invention, the terminal 20 is not limited to the V2X terminal, and may be any type of terminal that performs D2D communication. For example, the terminal 20 may be a terminal held by a user, such as a smartphone, or may be an Internet of Things (IoT) device, such as a smart meter and the like.

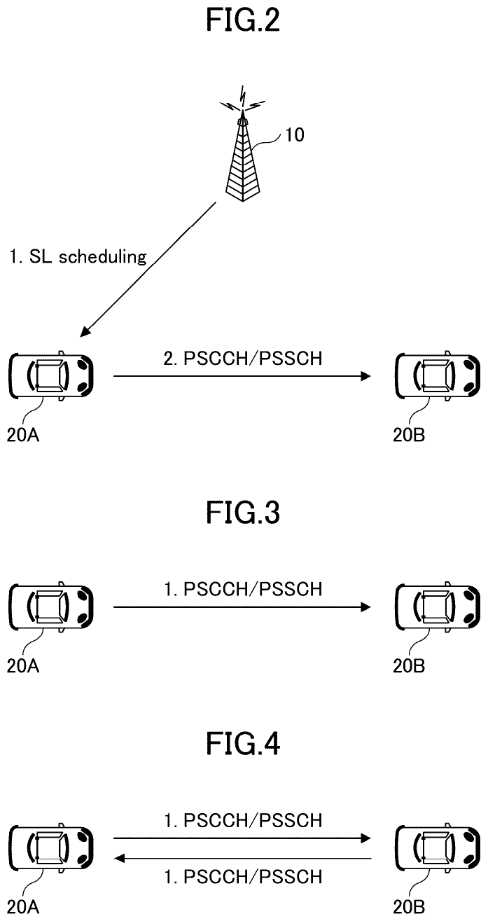

FIG. 2 is a diagram for explaining an example (1) of a transmission mode of the V2X. In the transmission mode of the sidelink communication illustrated in FIG. 2, in step 1, the base station 10 transmits a sidelink scheduling to a terminal 20A. Next, the terminal 20A transmits a Physical Sidelink Control Channel (PSCCH) and a Physical Sidelink Shared Channel (PSSCH) to a terminal 20B, based on the received scheduling (step 2). The transmission mode of sidelink communication illustrated in FIG. 2 may be referred to as a sidelink transmission mode 3 of the LTE. In the sidelink transmission mode 3 of the LTE, a Uu-based sidelink scheduling is performed. The Uu is a radio interface between a Universal Terrestrial Radio Access Network (UTRAN) and a User Equipment (UE). The transmission mode of the sidelink communication illustrated in FIG. 2 may be referred to as a sidelink transmission mode 1 of the NR.

FIG. 3 is a diagram for explaining an example (2) of the transmission mode of the V2X. In the transmission mode of sidelink communication illustrated in FIG. 3, in step 1, the terminal 20A transmits the PSCCH and the PSSCH to a terminal 20B by using the autonomously selected resource. The transmission mode of the sidelink communication illustrated in FIG. 3 may be referred to as a sidelink transmission mode 4 of the LTE. In the sidelink transmission mode 4 of the LTE, the UE itself performs the resource selection.

FIG. 4 is a diagram for explaining an example (3) of the transmission mode of the V2X. In the transmission mode of the sidelink communication illustrated in FIG. 4, in step 1, the terminal 20A transmits the PSCCH and the PSSCH to the terminal 20B by using the autonomously selected resource. Similarly, the terminal 20B transmits the PSCCH and the PSSCH to the terminal 20A by using the autonomously selected resource (step 1). The transmission mode of sidelink communication illustrated in FIG. 4 may be referred to as a sidelink transmission mode 2a of the NR. In the sidelink transmission mode 2 of the NR, the terminal 20 itself performs the resource selection.

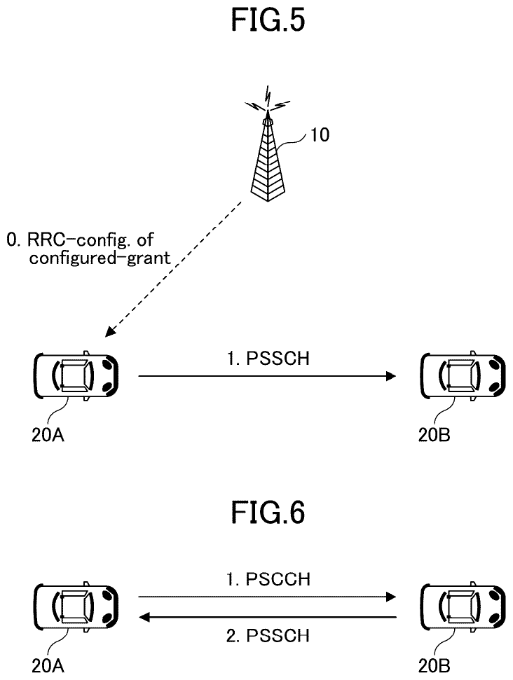

FIG. 5 is a diagram for explaining an example (4) of the transmission mode of the V2X. In the transmission mode of the sidelink communication illustrated in FIG. 5, in step 0, a resource pattern of the sidelink is transmitted from the base station 10 to the terminal 20A via a Radio Resource Control (RRC) configuration, or is pre-configured. Next, the terminal 20A transmits the PSSCH to the terminal 20B, based on the resource pattern (step 1). The transmission mode of the sidelink communication illustrated in FIG. 5 may be referred to as a sidelink transmission mode 2c of the NR.

FIG. 6 is a diagram for explaining an example (5) of the transmission mode of the V2X. In the transmission mode of the sidelink communication illustrated in FIG. 6, in step 1, the terminal 20A transmits a sidelink scheduling to the terminal 20B via the PSCCH. Next, the terminal 20B transmits a PSSCH to the terminal 20A based on the received scheduling (step 2). The transmission mode of the sidelink communication illustrated in FIG. 6 may be referred to as a sidelink transmission mode 2d of the NR.

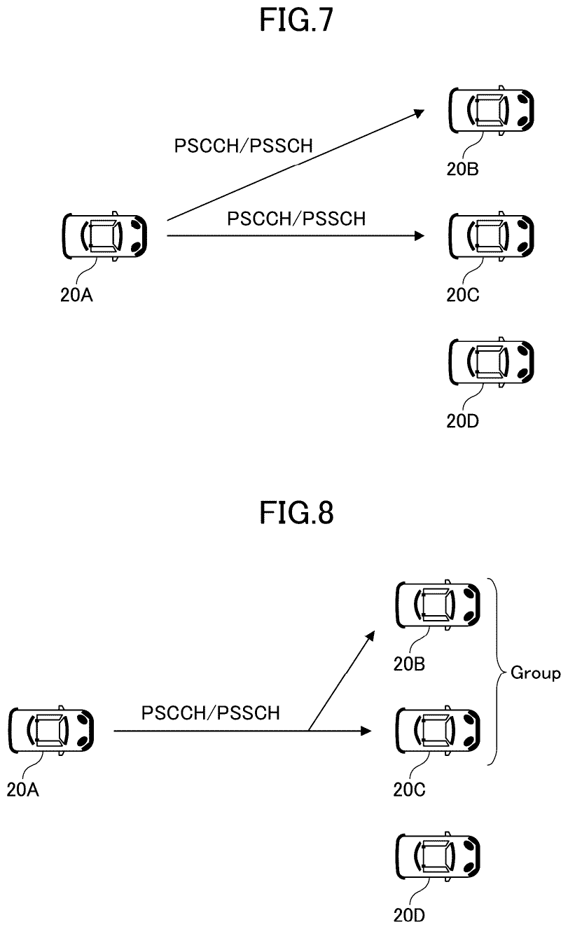

FIG. 7 is a diagram for explaining an example (1) of a communication type of the V2X. The communication type of the sidelink illustrated in FIG. 7 is unicast. The terminal 20A transmits the PSCCH and the PSSCH to the terminals 20. In the example illustrated in FIG. 7, the terminal 20A performs the unicast to the terminal 20B and performs the unicast to the terminal 20C.

FIG. 8 is a diagram for explaining an example (2) of the communication type of the V2X. The communication type of the sidelink illustrated in FIG. 8 is groupcast. The terminal 20A transmits the PSCCH and the PSSCH to a group to which one or a plurality of terminals 20 belong. In the example illustrated in FIG. 8, the group includes the terminal 20B and the terminal 20C, and the terminal 20A perform the groupcast to the group.

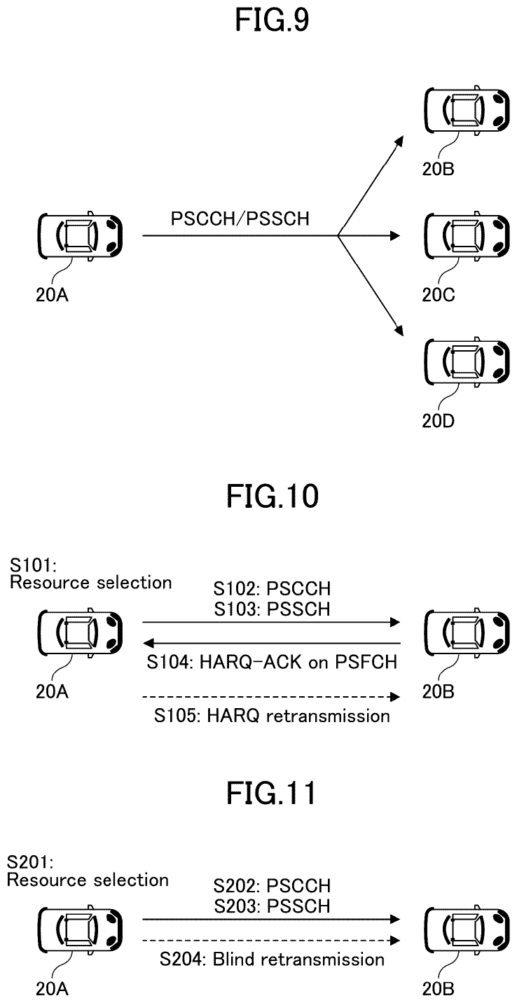

FIG. 9 is a diagram for explaining an example (3) of the communication type of the V2X. The communication type of the sidelink illustrated in FIG. 9 is broadcast. The terminal 20A transmits the PSCCH and the PSSCH to one or a plurality of terminals 20. In the example illustrated in FIG. 9, the terminal 20A broadcasts to the terminal 20B, the terminal 20C, and a terminal 20D. The terminal 20A illustrated in FIG. 7 through FIG. 9 may be referred to as a header-UE.

In addition, in the NR-V2X, it may be assumed that the HARQ (Hybrid Automatic Repeat Request) is supported by the unicast and the groupcast of the sidelink. Moreover, in the NR-V2X, a SFCI (Sidelink Feedback Control Information) including a HARQ response is defined. Further, there are studies to transmit the SFCI via a Physical Sidelink Feedback Channel (PSFCH).

In the following description, the PSFCH is used in the transmission of the HARQ-ACK in the sidelink, but this is merely an example. For example, the PSCCH may be used in the transmission of the HARQ-ACK in the sidelink, or the PSSCH may be used in the transmission of the HARQ-ACK in the sidelink, or an other channel may be used in the transmission of the HARQ-ACK in the sidelink.

Hereinafter, for the sake of convenience, all information reported by the terminal 20 in the HARQ will be referred to as the HARQ-ACK. The HARQ-ACK may be referred to as HARQ-ACK information. More specifically, a codebook applied to the HARQ-ACK information reported from the terminal 20 to the base station 10 and the like is referred to as a HARQ-ACK codebook. The HARQ-ACK codebook prescribes a bit sequence of the HARQ-ACK information. In addition to ACK, NACK is also transmitted by the “HARQ-ACK”.

FIG. 10 is a sequence diagram illustrating an operation example (1) of the V2X. As illustrated in FIG. 10, the wireless communication system according to the embodiment of the present invention may include the terminal 20A and the terminal 20B. Although a large number of user devices are actually present, FIG. 10 illustrates the terminal 20A and the terminal 20B as an example of the large number of user devices.

Hereinafter, when not particularly distinguishing the terminals 20A, 20B and the like, the terminals are simply referred to as “terminals 20” or “user devices”. Although FIG. 10 illustrates an example of a case where both the terminal 20A and the terminal 20B are located within the coverage of the cell, the operation according to the embodiment of the present invention can be applied to a case where the terminal 20B is located outside the coverage.

As described above, in the present embodiment, the terminal 20 is a device installed in the vehicle, such as an automobile and the like, for example, and the terminal 20 has a cellular communication function as a UE of the LTE or the NR, and a sidelink function. The terminal 20 may be a general mobile terminal (a smartphone and the like). The terminal 20 may be an RSU. The RSU may be a UE type RSU having the functions of the UE, or may be a gNB type RSU having functions of a base station apparatus.

The terminal 20 does not need to be a device housed within a single housing, and even in a case where various sensors are distributively disposed within the vehicle, for example, a device including the various sensors may form the terminal 20.

In addition, the processing content of the sidelink transmission data of the terminal 20 is basically similar to the processing content of the UL transmission in the LTE or the NR. For example, the terminal 20 generates complex-valued symbols by scrambling and modulating codewords of transmission data, maps the complex-valued symbols (transmission signals) in one or two layers, and performs a precoding. Then, the precoded complex-valued symbols are mapped to resource elements to generate a transmission signal (for example, a complex-valued time-domain SC-FDMA signal), and the transmission signal is transmitted from each antenna port.

The base station 10 has a cellular communication function as a base station of the LTE or the NR, and a function (for example, a resource pool configuration, a resource allocation, and the like) for enabling communication of the terminal 20 according to the present embodiment. Moreover, the base station 10 may be an RSU (gNB type RSU).

Further, in the wireless communication system according to the embodiment of the present invention, a signal waveform used by the terminal 20 for the SL or the UL may be OFDMA, SC-FDMA, or other signal waveforms.

In step S101, the terminal 20A autonomously selects resources to be used for the PSCCH and the PSSCH from a resource selection window having a predetermined period. The resource selection window may be configured in the terminal 20 from the base station 10. In this case, the predetermined period of the resource selection window may be prescribed by a terminal implementation condition such as a processing time or a maximum allowable delay time, or may be prescribed in advance by specifications, for example, and the predetermined period may be referred to as an interval in the time domain.

In step S102 and step S103, the terminal 20A transmits Sidelink Control Information (SCI) by the PSCCH and/or the PSSCH, and transmits SL data by the PSSCH, using the resource autonomously selected in step S101. For example, the terminal 20A may transmit the PSCCH using a time resource which is the same as at least a part of a time resource of the PSSCH, and a frequency resource which is adjacent or not adjacent to a frequency resource of the PSSCH.

The terminal 20B receives the SCI (PSCCH and/or PSSCH) and the SL data (PSSCH) transmitted from the terminal 20A. The received SCI may include information on a PSFCH resource for the terminal 20B to transmit the HARQ-ACK in response to the data reception. The terminal 20A may transmit the information of the autonomously selected resource by including the information in the SCI.

In step S104, the terminal 20B transmits the HARQ-ACK to the terminal 20A in response to the received data, using the PSFCH resource determined from the received SCI.

In a case where the HARQ-ACK received in step S104 indicates a request for retransmission, that is, a negative acknowledgement (NACK), the terminal 20A retransmits the PSCCH and the PSSCH to the terminal 20B in step S105. The terminal 20A may retransmit the PSCCH and the PSSCH using the autonomously selected resource. In a case where a HARQ control with HARQ feedback is not performed, step S104 and step S105 do not need to be executed.

FIG. 11 is a sequence diagram illustrating an operation example (2) of the V2X. A blind retransmission not based on the HARQ control for improving a success rate of the transmission or a transmission range may be performed.

In step S201, the terminal 20A autonomously selects resources to be used for the PSCCH and the PSSCH from the resource selection window having the predetermined period. The resource selection window may be configured in the terminal 20 from the base station 10.

In step S202 and step S203, the terminal 20A transmits the SCI by the PSCCH and/or the PSSCH, and transmits the SL data by the PSSCH, using the resource autonomously selected in step S201. For example, the terminal 20A may transmit the PSCCH using the time resource which is the same as at least a part of the time resource of the PSSCH, and the frequency resource which is adjacent to the frequency resource of the PSSCH.

In step S204, the terminal 20A retransmits the SCI by the PSCCH and/or the PSSCH and the SL data by the PSSCH to the terminal 20B, using the resources autonomously selected in step S201. The retransmission in step S204 may be performed a plurality of times.

In a case where the blind retransmission is not performed, step S204 does not need to be performed.

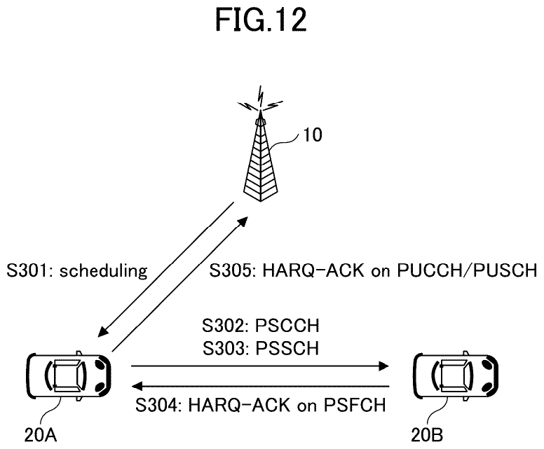

FIG. 12 is a sequence diagram illustrating an operation example (3) of the V2X. The base station 10 may perform a scheduling of the sidelink. That is, the base station 10 may determine the resource of the sidelink to be used by the terminal 20, and transmit information indicating the resource to the terminal 20. Further, in the case where the HARQ control with the HARQ feedback is applied, the base station 10 may transmit information indicating the PSFCH resource to the terminal 20.

In step S301, the base station 10 performs an SL scheduling by transmitting Downlink Control Information (DCI) with respect to the terminal 20A by the PDCCH. Hereinafter, for the sake of convenience, the DCI for the SL scheduling will be referred to as an SL scheduling DCI.

In addition, in step S301, it is assumed that the base station 10 also transmits the DCI for a DL scheduling (which may be referred to as a DL allocation) with respect to the terminal 20A by the PDCCH. Hereinafter, for the sake of convenience, the DCI for the DL scheduling will be referred to as a DL scheduling DCI. The terminal 20A, which receives the DL scheduling DCI, receives DL data by the PDSCH using a resource specified by the DL scheduling DCI.

In step S302 and step S303, the terminal 20A transmits the Sidelink Control Information (SCI) by the PSCCH and/or the PSSCH, and transmits the SL data by the PSSCH, using the resources specified by the SL scheduling DCI. Only the PSSCH resource may be specified by the SL scheduling DCI. In this case, the terminal 20A may transmit the PSCCH using the time resource which is the same as at least a part of the time resource of the PSSCH, and the frequency resource which is adjacent to the frequency resource of the PSSCH, for example.

The terminal 20B receives the SCI (PSCCH and/or PSSCH) and the SL data (PSSCH) transmitted from the terminal 20A. The SCI received by the PSCCH and/or the PSSCH includes information on the PSFCH resource for the terminal 20B to transmit the HARQ-ACK in response to the data reception.

The information on the resource is included in the DL scheduling DCI or the SL scheduling DCI transmitted from the base station 10 in step S301, and the terminal 20A acquires the information on the resource from the DL scheduling DCI or the SL scheduling DCI and includes the information in the SCI. Alternatively, the DCI transmitted from the base station 10 may not include the information on the resource, and the terminal 20A may autonomously include the information on the resource in the SCI and transmit the SCI including the information on the resource.

In step S304, the terminal 20B transmits the HARQ-ACK with respect to the received data to the terminal 20A, using the PSFCH resource determined from the received SCI.

In step S305, the terminal 20A transmits the HARQ-ACK at a timing (for example, a timing in units of slots) specified by the DL scheduling DCI (or the SL scheduling DCI), using a Physical Uplink Control Channel (PUCCH) specified by the DL scheduling DCI (or the SL scheduling DCI), for example, and the base station 10 receives the HARQ-ACK. The HARQ-ACK codebook may include a HARQ-ACK received from the terminal 20B or a HARQ-ACK generated based on the PSFCH which is not received, and a HARQ-ACK with respect to the DL data. However, in a case where there is no allocation of the DL data and the like, the HARQ-ACK with respect to the DL data is not included. In NR Rel. 16, the HARQ-ACK with respect to the DL data is not included in the HARQ-ACK codebook.

In the case where the HARQ control with the HARQ feedback is not performed, step S304 and/or step S305 do/does not need to be performed.

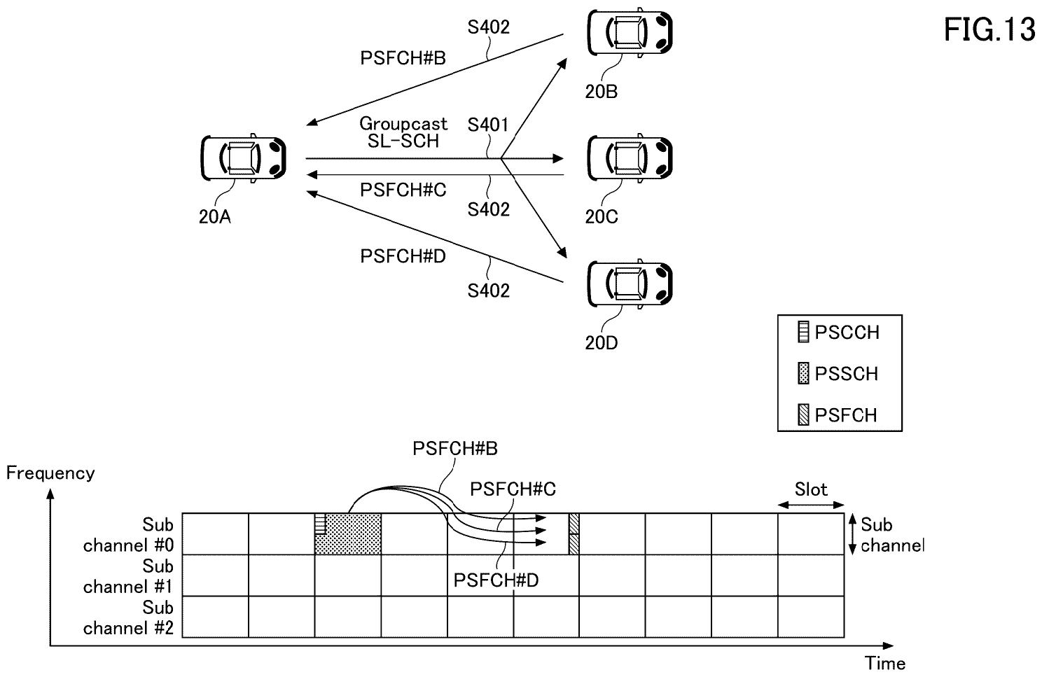

FIG. 13 is a sequence diagram illustrating an operation example (4) of the V2X. As described above, the transmission of the HARQ response by the PSFCH is supported by the NR sidelink. The PSFCH may use a format similar to a Physical Uplink Control Channel (PUCCH) format 0, for example. That is, the format of the PSFCH may be a sequence based format in which a Physical Resource Block (PRB) size is 1 and the ACK and the NACK are identified according to differences in a sequence and/or a cyclic shift. The format of the PSFCH is not limited to the format described above. The PSFCH resource may be arranged in a symbol at a tail of the slot, or in a plurality of symbols at the tail of the slot. In addition, a period N is configured or prescribed in advance for the PSFCH resource. The period N may be configured in units of slots or may be prescribed in advance.

In FIG. 13, the ordinate corresponds to the frequency domain, and the abscissa corresponds to the time domain. The PSCCH may be arranged in one symbol at the head of the slot, or may be arranged in a plurality of symbols from the head of the slot, or may be arranged in a plurality of symbols from a symbol other than at the head of the slot. The PSFCH may be arranged in one symbol at the tail of the slot, or may be arranged in a plurality of symbols at the tail of the slot. The “head of the slot” and the “tail of the slot” described above may omit consideration of a symbol for Automatic Gain Control (AGC) and a symbol for transmission/reception switching. That is, in a case where one slot is composed of 14 symbols, for example, the “head of the slot” and the “tail of the slot” may refer to the head symbol and the tail symbol, respectively, for the 12 symbols excluding the head symbol and the tail symbol of the slot. In the example illustrated in FIG. 13, three sub channels are configured in the resource pool, and two PSFCHs are arranged three slots after the slot in which the PSSCH is arranged. An arrow from the PSSCH to the PSFCH indicates an example of the PSFCH associated with the PSSCH.

In a case where the HARQ response in the groupcast of the NR-V2X is the groupcast option 2 which transmits the ACK or the NACK, it is necessary to determine the resource to be used for the transmission and reception of the PSFCH. As illustrated in FIG. 13, in step S401, the terminal 20A, which is the transmitting terminal 20, performs the groupcast to the terminal 20B, the terminal 20C, and the terminal 20D, which are the receiving terminals 20, via the SL-SCH. In following step S402, the terminal 20B uses a PSFCH #B, the terminal 20C uses a PSFCH #C, and the terminal 20D uses a PSFCH #D, to transmit the HARQ response to the terminal 20A. As illustrated in the example of FIG. 13, in a case where the number of available PSFCH resources is smaller than the number of the receiving terminals 20 belonging to the group, it is necessary to determine how to allocate the PSFCH resources. The transmitting terminal 20 may grasp the number of the receiving terminals 20 for the groupcast. In the groupcast option 1, only the NACK is transmitted as the HARQ response, and the ACK is not transmitted.

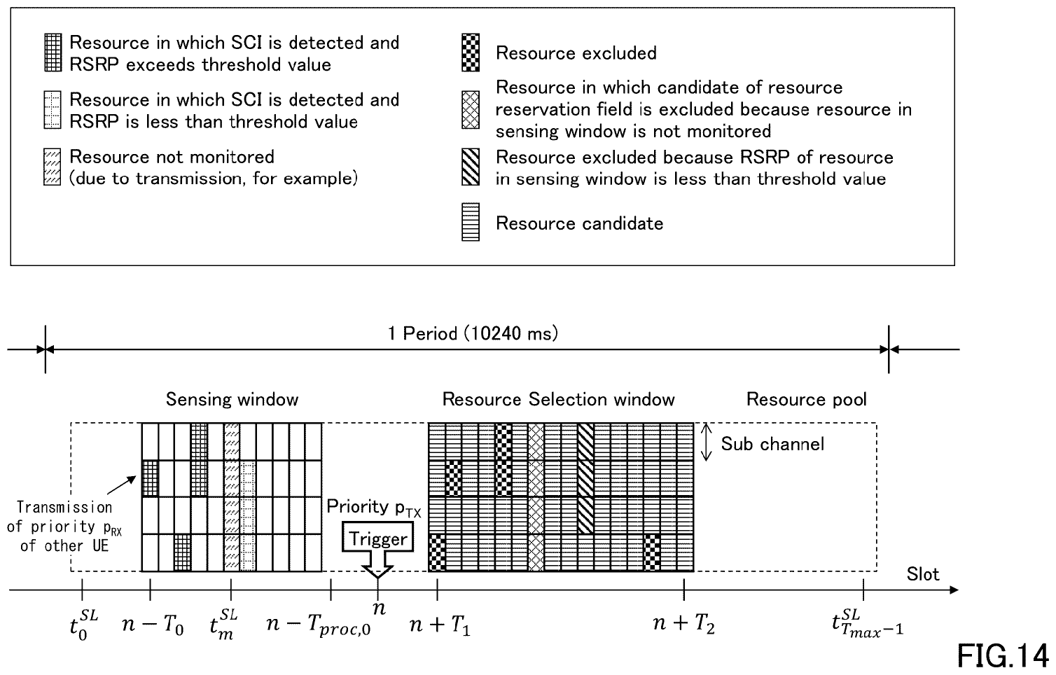

FIG. 14 is a diagram illustrating an example of a sensing operation of the NR. In the Resource Allocation Mode 2, the terminal 20 selects a resource and performs the transmission. As illustrated in FIG. 14, the terminal 20 performs a sensing in a sensing window within the resource pool. By this sensing, the terminal 20 receives a resource reservation field or a resource assignment field included in the SCI transmitted from an other terminal 20, and identifies available resource candidates in a resource selection window within the resource pool, based on the received field. Next, the terminal 20 selects a resource at random from the available resource candidates.

Further, as illustrated in FIG. 14, the resource pool may be periodically configured. For example, the period may be an interval of 10240 milliseconds. FIG. 14 illustrates an example in which the resource pool is configured by slots from a slot t₀^{SL} to a slot t_{Tmax-1}^{SL}. Regions of the resource pool in each period may be configured by a bitmap, for example.

In addition, as illustrated in FIG. 14, it is assumed that a transmission trigger of the terminal 20 is generated in a slot n, and the transmission has a priority p_{TX}. The terminal 20 can detect that the other terminal 20 is making a transmission having a priority p_{RX}, for example, in the sensing window from a slot n-T₀ to a slot immediately before a slot n-T_{proc,0}. In a case where an SCI is detected within the sensing window and a Reference Signal Received Power (RSRP) exceeds a threshold value, resources within a resource selection window corresponding to the SCI are excluded. Moreover, in a case where the SCI is detected within the sensing window and the RSRP is less than the threshold value, the resources within the resource selection window corresponding to the SCI are not excluded. The threshold value may be a threshold value Th_{pTX,pRX} that is configured or defined for each resource within the sensing window, based on the priority p_{TX} and the priority p_{RX}, for example.

Further, as in a slot tₘ^{SL} illustrated in FIG. 14, resources within the resource selection window which become candidates for the resource reservation information corresponding to resources within the sensing window not monitored for the transmission, for example, are excluded.

In a resource selection window from the slot n+T₁ to a slot n+T₂, the resources occupied by the other UE are identified as illustrated in FIG. 14, and the resources from which the resources occupied by the other UE are excluded become the available resource candidates. When a set of the available resource candidates is denoted by S_{A} and the set S_{A} is less than 20% of the resource selection window, the threshold value Th_{pTX,pRX} configured for each resource of the sensing window may be increased by 3 dB to again perform the identification of the resource. That is, the threshold value Th_{pTX,pRX} may be increased and the identification of the resource may be performed again, so that the resources that are not excluded because the RSRP is less than the threshold value can be increased, and the set S_{A} of the resource candidates becomes 20% or more of the resource selection window. In the case where the set S_{A} is less than 20% of the resource selection window, the operation of increasing the threshold value Th_{pTX,pRX} configured for each resource of the sensing window by 3 dB and again performing the identification of the resource may be repeated.

A lower layer of the terminal 20 may report the set S_{A} to a higher layer. The higher layer of the terminal 20 may determine the resource to be used by performing a random selection with respect to the set S_{A}. The terminal 20 may perform a sidelink transmission using the determined resource. For example, the higher layer may be a MAC layer, and the lower layer may be a PHY layer or a physical layer.

Although the operation of the transmitting terminal 20 is described above in conjunction with FIG. 14, the receiving terminal 20 may detect the data transmission from the other terminal 20, based on the result of sensing or partial sensing, and receive data from the other terminal 20.

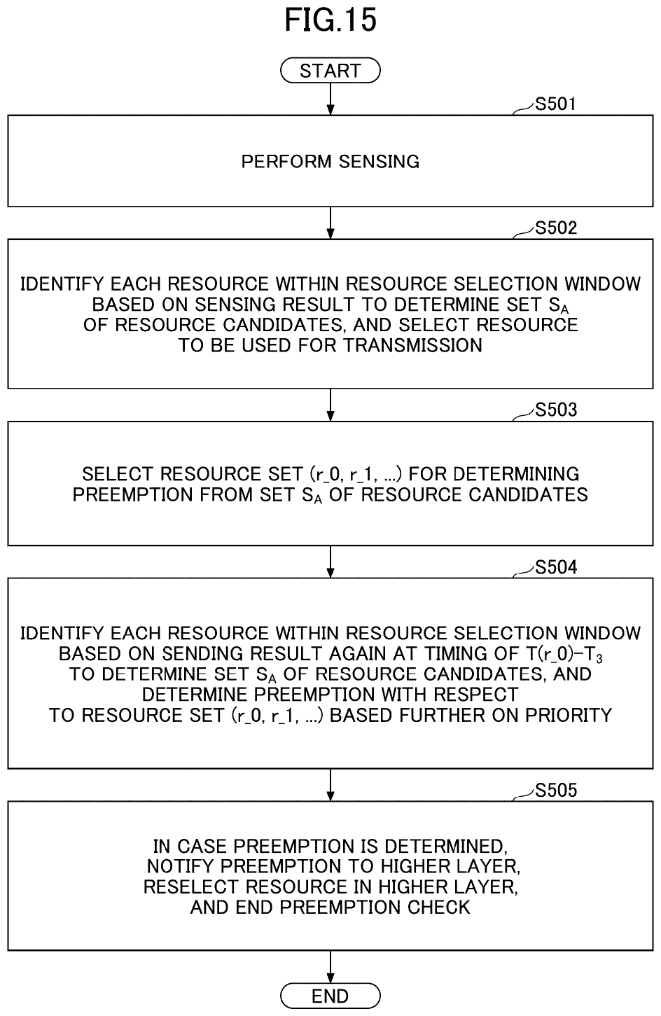

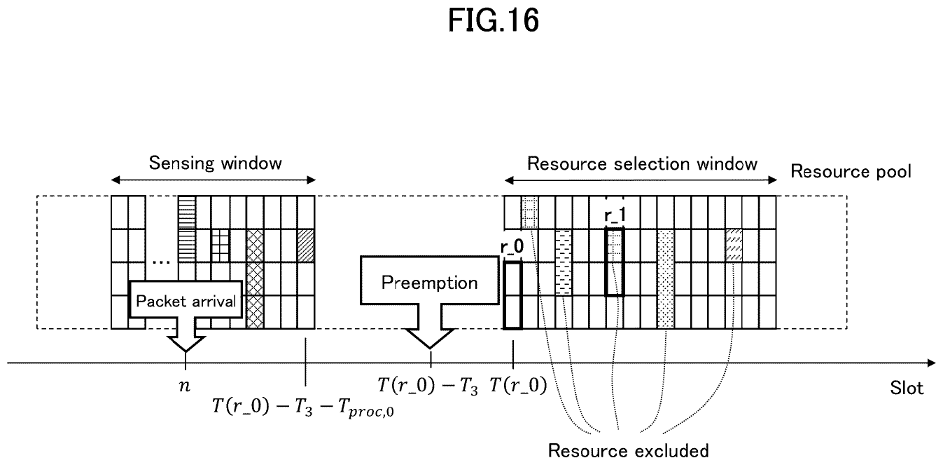

FIG. 15 is a flow chart illustrating an example of a preemption of the NR. FIG. 16 is a diagram illustrating an example of the preemption of the NR. In step S501, the terminal 20 performs a sensing in the sensing window. In a case where the terminal 20 performs a power saving operation, the sensing may be performed in a limited period that is prescribed in advance. Next, the terminal 20 determines the set S_{A} of resource candidates by identifying each resource within the resource selection window based on the sensing result, and selects a resource to be used for the transmission (S502). Next, the terminal 20 selects a resource set (r_0, r_1, . . . ) for determining the preemption from the set S_{A} of resource candidates (S503). The resource set may be notified from the higher layer to the PHY layer as a resource for determining whether or not the preemption occurred.

In step S504, at a timing T (r_0)-T₃ illustrated in FIG. 16, the terminal 20 identifies each resource within the resource selection window again based on the sensing result to determine the set S_{A} of resource candidates, and further determines the preemption with respect to the resource set (r_0, r_1, . . . ) based on the priority. For example, in the case of a resource r_1 illustrated in FIG. 16, the SCI transmitted from the other terminal 20 is detected by the re-sensing, and is not included in the set S_{A}. In a case where the preemption is enabled, and a value prio_RX indicating the priority of the SCI transmitted from the other terminal 20 is lower than a value prio_TX indicating the priority of a transport block transmitted from the local terminal, the terminal 20 determines that the preemption of the resource r_1 occurred. The lower the value indicating the priority, the higher the priority. That is, in the case where the value prio_RX indicating the priority of the SCI transmitted from the other terminal 20 is higher than the value prio_TX indicating the priority of the transport block transmitted from the local terminal, the terminal 20 does not exclude the resource r_1 from the set S_{A}. Alternatively, in a case where the preemption is only enabled for a particular priority (for example, s1-PreemptionEnable is one of p11, p12, . . . , p18), this priority is set to prio_pre. In this state, in a case where the value prio_RX indicating the priority of the SCI transmitted from the other terminal 20 is lower than prio_pre, and prio_RX is lower than the value prio_TX indicating the priority of the transport block transmitted from the local terminal, the terminal 20 determines that the preemption of the resource r_1 occurred.

In step S505, in a case where the preemption is determined in step S504, the terminal 20 notifies the higher layer of the preemption, performs a resource reselection in the higher layer, and ends the preemption check.

In a case where a re-evaluation is performed in place of checking the preemption, after the set S_{A} of resource candidates is determined in step S504 described above, if a resource of the resource set (r_0, r_1, . . . ), is not included in the set S_{A}, the resource is not used, and a resource reselection is performed in the higher layer.

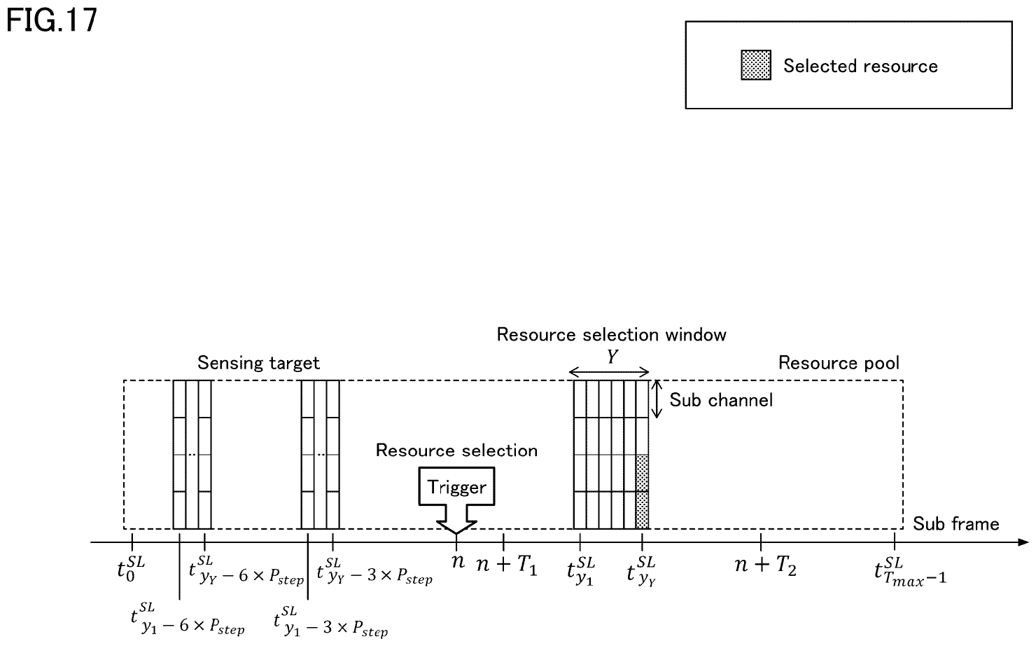

FIG. 17 is a diagram illustrating an example of a partial sensing operation of the LTE. In a case where the partial sensing is configured from the higher layer in the LTE sidelink, the terminal 20 selects a resource and performs the transmission as illustrated in FIG. 17. As illustrated in FIG. 17, the terminal 20 performs a partial sensing with respect to a part of the sensing window in the resource pool, that is, a sensing target. By this partial sensing, the terminal 20 receives the resource reservation field included in the SCI transmitted from the other terminal 20, and identifies the available resource candidates within the resource selection window in the resource pool based on the resource reservation field. Next, the terminal 20 randomly selects a resource from the available resource candidates.

FIG. 17 illustrates an example in which a sub frame t₀^{SL} to a sub frame t_{Tmax-1}^{SL} are configured as the resource pool. A target region of the resource pool may be configured by a bitmap, for example. As illustrated in FIG. 17, it is assumed that the transmission trigger in the terminal 20 occurs at a sub frame n. As illustrated in FIG. 17, Y sub frames from a sub frames t_{y1}^{SL} to a sub frame t_{yY}^{SL}, among sub frames from a sub frame n+T₁ to a sub frame n+T₂, may be configured as the resource selection window.

The terminal 20 can detect that the other terminals 20 is performing a transmission, for example, in one or a plurality of sensing targets from a sub frame t_{y1-k×Pstep}^{SL} to a sub frame t_{yY-k×Pstep}^{SL} having a length of Y sub frames. k may be determined by a 10-bit bitmap, for example. FIG. 17 illustrates an example in which the third and sixth bits of the bitmap are set to “1” indicating that partial sensing is to be performed. That is, in FIG. 17, a sub frame t_{y1-6×Pstep}^{SL} to a sub frame t_{yY-6×Pstep}^{SL}, and a sub frame t_{y1-3×Pstep}^{SL} to a sub frame t_{yY-3×Pstep}^{SL}, are configured as the sensing targets. As described above, the kth bit of the bitmap may correspond to the sensing window from the sub frame t_{y1-k×Pstep}^{SL} to the sub frame t_{yY-k×Pstep}^{SL}. yᵢ corresponds to an index (1. . . . Y) in the Y sub frames.

In addition, k may be configured or prescribed in advance by the 10-bit bitmap, and Pstep may be 100 ms. However, in a case where the SL communication is performed in the DL and UL carriers, Pₛₜₑₚ may be (U/(D+S+U))*100 ms. U corresponds to the number of UL sub frames, D corresponds to the number of DL sub frames, and S corresponds to the number of special sub frames.

In a case where the SCI is detected in the sensing target described above and the RSRP exceeds the threshold value, the resources in the resource selection window corresponding to the resource reservation field of the SCI are excluded. On the other hand, in a case where the SCI is detected in the sensing target and the RSRP is less than the threshold value, the resources in the resource selection window corresponding to the resource reservation field of the SCI are not excluded. The threshold value may be the threshold value Th_{pTX,pRX} configured or defined for each resource in the sensing target, based on the transmitting priority p_{TX} and the receiving priority p_{RX}, for example.

As illustrated in FIG. 17, in the resource selection window configured in the Y sub frames of an interval [n+T₁, n+T₂], the terminal 20 identifies the resource occupied by the other UE, and the resources excluding the occupied resource become the available resource candidates. The Y sub frames do not need to be consecutive. When the set of available resource candidates is denoted by S_{A}, and in a case where the set S_{A} is less than 20% of the resources of the resource selection window, the threshold value Th_{pTX,pRX} configured for each resource of the sensing target may be increased by 3 dB and the identification of the resource may be performed again.

That is, the resource that is not excluded because the RSRP is less than the threshold value may be increased by increasing the threshold value Th_{pTX,pRX} and performing the identification of the resource again. Further, the RSSI of each resource in the set S_{A} may be measured, and the resource with the minimum RSSI may be added to a set S_{B}. The operation of adding the resource with the minimum RSSI included in the set S_{A} to the set S_{B} of the resource candidates may be repeated until the set S_{B} becomes 20% or more of the resource selection window.

The lower layer of the terminal 20 may report the set S_{B} to the higher layer. The higher layer of the terminal 20 may determine the resource to be used by performing a random selection with respect to the set S_{B}. The terminal 20 may perform a sidelink transmission using the determined resource. After a resource is secured once, the terminal 20 may periodically use the resource a predetermined number of times (for example, Cᵣₑₛₑₗ times) without performing the sensing.

In the NR Release 17 Sidelink, power saving based on random resource selection and partial sensing is being studied. For example, for the power saving, the random resource selection and the partial sensing of the sidelink in LTE Release 14 may be applied to the Resource Allocation Mode 2 of the NR Release 16 sidelink. The terminal 20 to which partial sensing is applied performs the reception and the sensing only in specific slots within the sensing window.

Further, in the NR Release 17 Sidelink, operation is being studied with inter-UE coordination as a baseline. For example, the terminal 20A may share information indicating the resource set with the terminal 20B, and the terminal 20B may consider the information in a resource selection for the transmission.

For example, as a resource allocation method in the sidelink, the terminal 20 may perform a full sensing, as illustrated in FIG. 14. In addition, the terminal 20 may perform a partial sensing in which the terminal 20 identifies the resources by sensing only limited resources when compared to the full sensing and selects a resource from the identified resource set. Moreover, the terminal 20 may perform a random selection in which the resources in the resource selection window are regarded as the identified resource set and the resource is selected from the identified resource set, without excluding resources from the resources in the resource selection window.

A method of performing a random selection at the time of resource selection and using sensing information at the time of re-evaluation or preemption check may be treated as the partial sensing or may be treated as the random selection.

The following 1) and 2) may be applied as an operation during the sensing. The sensing and monitoring may be replaced with each other, and at least one of the measurement of received RSRP, acquisition of reservation resource information, and acquisition of priority information may be included in the operation.

### 1) Periodic-Based Partial Sensing:

This operation determines a sensing slot based on a reservation periodicity, in a mechanism for sensing only in some of the slots. The reservation periodicity is a value associated with a resource reservation period field. The period may be replaced with periodicity.

### 2) Contiguous Partial Sensing:

This operation determines a sensing slot based on an aperiodic reservation, in the mechanism for sensing only some of the slots. The aperiodic reservation is a value associated with a time resource assignment field.

In the Release 17, the operation may be prescribed by assuming three types of terminals 20. One type is a type A, and the terminal 20 of the type A does not have the capability of receiving any sidelink signal and channel. However, the capability of receiving the PSFCH and the S-SSB may be an exception.

An other type is a type B, and the terminal 20 of the type B does not have a capability of receiving any sidelink signal and channel, except for the PSFCH and the S-SSB reception.

An other type is a type D, and the terminal 20 of the type D has the capability of receiving all sidelink signals and channels defined in the Release 16. However, the capability of receiving some sidelink signals and channels is not excluded.

UE types other than the type A, the type B, and the type D described above may be assumed, and the UE type and the UE capability may not be associated with each other or may be associated with each other.

In addition, in the Release 17, a plurality of resource allocation methods may be configured for a certain resource pool. Further, as one of the power saving functions, Sidelink Discontinuous Reception (SL-DRX) is supported. That is, the reception operation is performed only during a predetermined time interval.

As described above, the partial sensing is supported as one of the power saving functions. In the resource pool in which the partial sensing is configured, the terminal 20 may perform the periodic-based partial sensing described above. The terminal 20 may receive, from the base station 10, information for configuring the resource pool in which the partial sensing is configured and the periodic reservation is configured to be enabled.

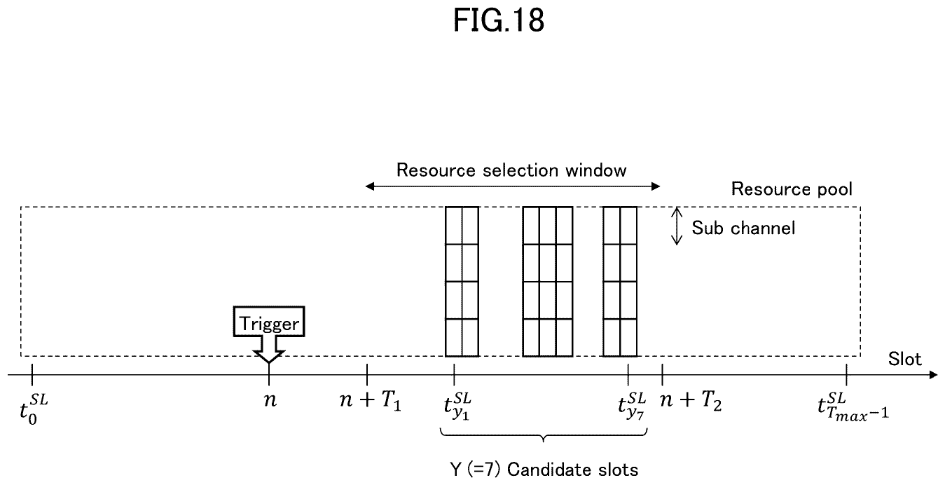

FIG. 18 is a diagram for explaining an example of periodic-based partial sensing. As illustrated in FIG. 18, Y candidate slots for resource selection are selected from the resource selection window [n+T₁, n+T₂].

The sensing may be performed using t_{y}^{SL} as being one slot included in the Y candidate slots, and t_{y-k×Preserve}^{SL} as being a target slot of the periodic-based partial sensing.

Pᵣₑₛₑᵣᵥₑ may correspond to all values included in sl-ResouceReservePeriodList which is configured or prescribed in advance. Alternatively, a value of Pᵣₑₛₑᵣᵥₑ limited to a subset of sl-ResouceReservePeriodList may be configured or prescribed in advance. Pᵣₑₛₑᵣᵥₑ and sl-ResouceReservePeriodList may be configured for each transmission resource pool of the Resource Allocation Mode 2. In addition, as a UE implementation, the period included in sl-ResouceReservePeriodList other than the limited subset may be monitored. For example, the terminal 20 may additionally monitor an opportunity corresponding to P_RSVP_Tx.

With respect to the k value, the terminal 20 may monitor the most recent sensing opportunity in a certain reservation period before the slot n of a resource selection trigger, or before the header slot of the Y candidate slots subject to a processing time limitation. In addition, the terminal 20 may additionally monitor a periodic sensing opportunity corresponding to a set of one or more k values. For example, a value corresponding to the most recent sensing opportunity in the certain reservation period before the slot n of the resource selection trigger or before the header slot of the Y candidate slots subject to the processing time limitation, and a value corresponding to the sensing opportunity immediately before the most recent sensing opportunity in the certain reservation period, may be set as the k values.

As described above, the partial sensing is supported as one of the power saving functions. In the resource pool in which the partial sensing is configured, the terminal 20 may perform the contiguous partial sensing described above. The terminal 20 may receive, from the base station 10, information for configuring the resource pool in which the partial sensing is configured and the aperiodic reservation is configured to be enabled.

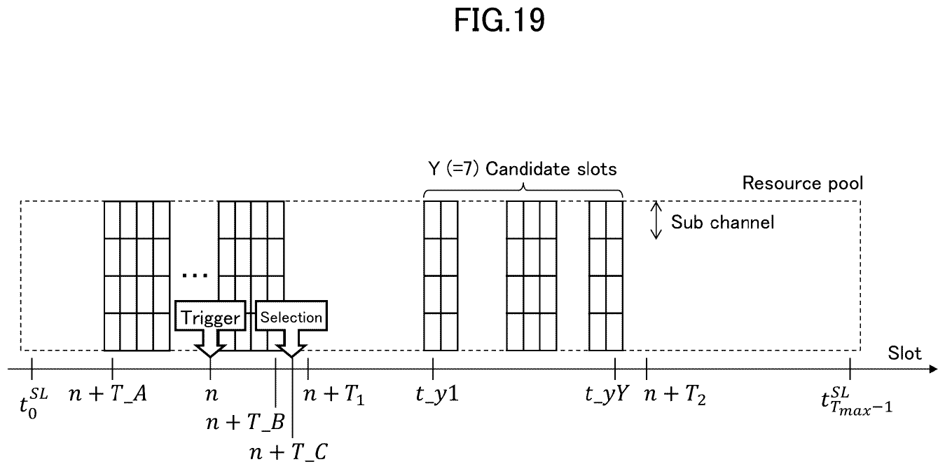

FIG. 19 is a diagram for explaining an example of contiguous partial sensing. As illustrated in FIG. 19, in a case where the trigger of the resource selection is the slot n, the terminal 20 selects the Y candidate slots for the resource selection from the resource selection window [n+T₁, n+T₂]. FIG. 19 illustrates an example of the case where Y=7. As illustrated in FIG. 19, the head of the

Y candidate slots is indicated by a slot t_{y1}, the next slot is indicated by a slot t_{y2}, . . . , and the tail of the Y candidate slots is indicated by a slot t_{yY}.

The terminal 20 performs the sensing in an interval [n+T_{A}, n+T_{B}], and performs the resource selection in n+T_{B} or after n+T_{B} (referred to as n+T_{C}). The periodic-based partial sensing described above may be additionally performed. T_{A} and T_{B} in the interval [n+T_{A}, n+T_{B}] may take any value. Further, n may be replaced with an index of any one of the Y candidate slots.

In addition, a symbol [may be replaced with a symbol (, and a symbol] may be replaced with a symbol). For example, an interval [a, b] is an interval from the slot a to the slot b, and includes the slot a and the slot b. For example, the interval (a, b) is an interval from the slot a to the slot b, and does not include the slot a and the slot b.

Although the candidate resources to be a target of the resource selection are described as the Y candidate slots, all of the slots in the interval [n+T₁, n+T₂] may be the candidate slots, or some of the slots may be the candidate slots.

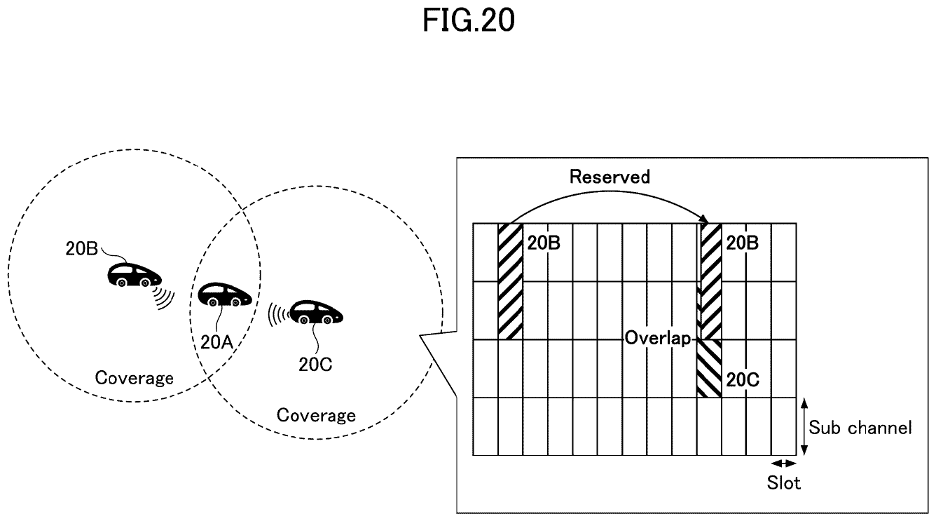

FIG. 20 is a diagram for explaining an example (1) of a communication state. As an example of the hidden terminal problem, as illustrated in FIG. 20, when the terminal 20B is to make a transmission to the terminal 20A, the terminal 20C, which cannot be detected by the terminal 20A, may be located at a position interfering with the receiving terminal 20B. For example, if the terminal 20C makes a transmission at a time resource reserved by the terminal 20A, a resource overlap occurs when the terminal 20B receives the transmission.

In addition, because the sidelink is a half-duplex communication, there is a possibility that a collision of resources will occur when both of the terminals 20 make the transmission.

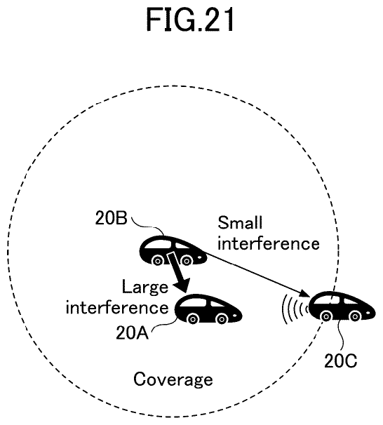

FIG. 21 is a diagram for explaining an example (2) of the communication state. As an example of the near-far problem, as illustrated in FIG. 21, when the terminal 20C is to make a transmission to the terminal 20A, the terminal 20B which is detected with a small power in the transmitting terminal 20C may be located at a position which greatly interferes with the receiving terminal 20A.

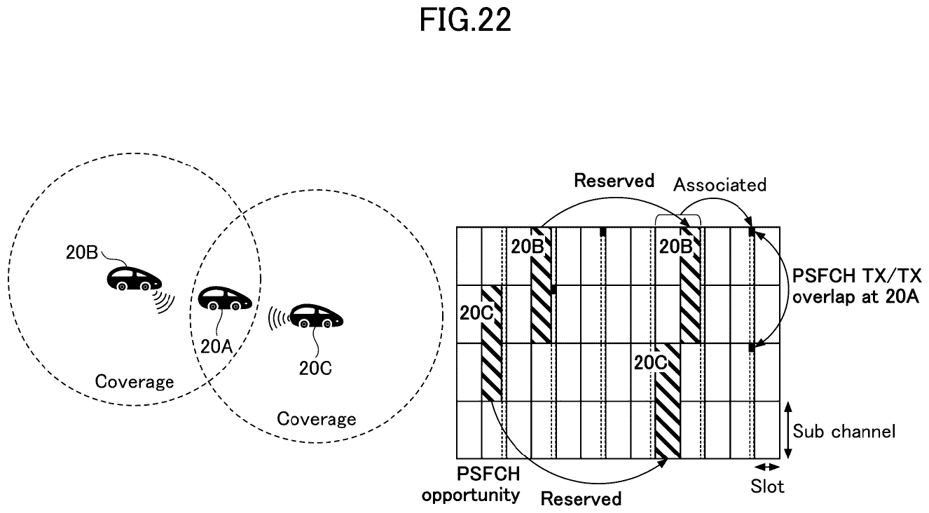

FIG. 22 is a diagram for explaining an example (3) of the communication state. As an example of the collision between the transmission resource and the transmission resource in the time domain, as illustrated in FIG. 22, there is a case where a PSFCH transmission resource reserved from the terminal 20B or associated with the PSSCH, and a PSFCH transmission resource reserved from the terminal 20C or associated with the PSSCH, overlap at the terminal 20A. In the case where multiple transmissions overlap, a drop or a power reduction occurs. For example, an overlap of the PSFCH and the PSFCH illustrated in FIG. 20, an overlap of the PSFCH and the UL channel, and the like may be assumed to occur.

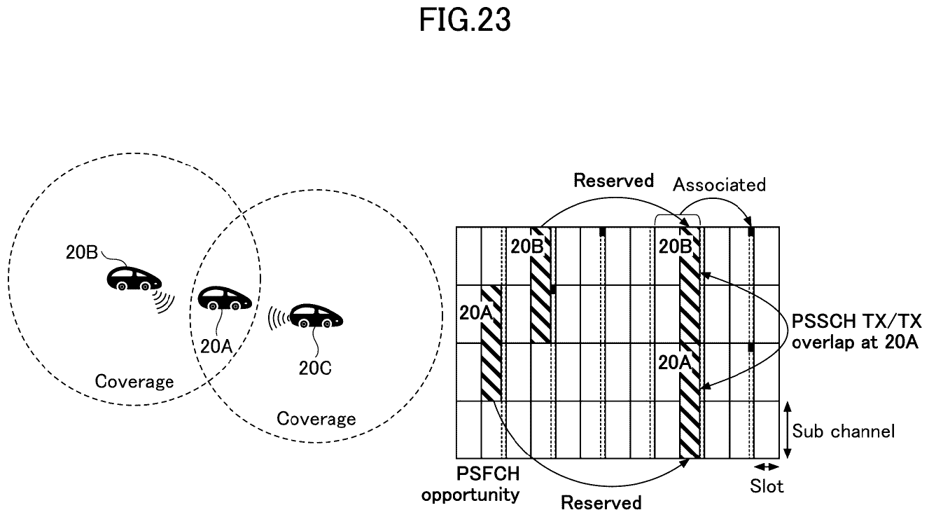

FIG. 23 is a diagram for explaining an example (4) of the communication state. As an example of a collision between the reception resource and the transmission resource in the time domain, as illustrated in FIG. 23, there is a case where the PSSCH reception in the resource reserved from the terminal 20B and the PSSCH transmission in the resource reserved from the terminal 20A overlap at the terminal 20A.

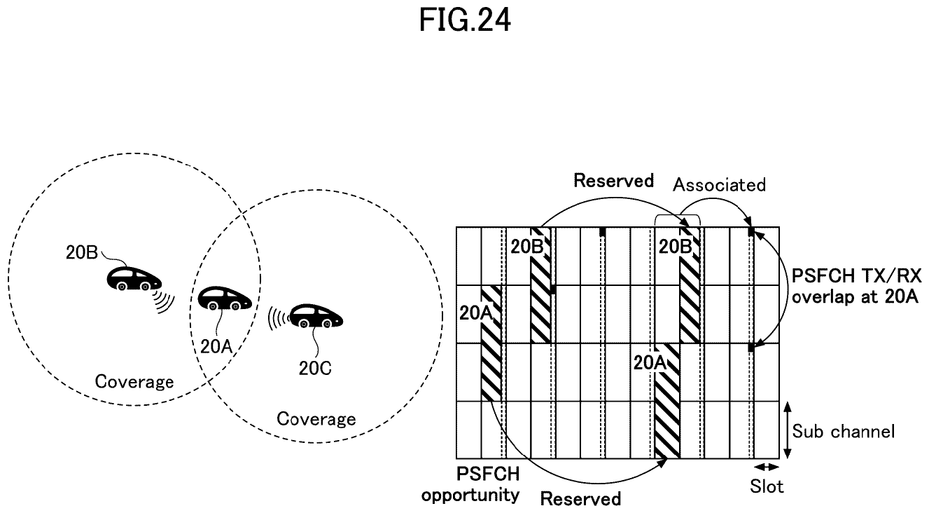

FIG. 24 is a diagram for explaining an example (5) of the communication state. As an example of a collision between the transmission resource and the reception resource in the time domain, as illustrated in FIG. 24, there is a case where the PSFCH associated with the PSSCH reserved from the terminal 20B and the PSFCH associated with the PSSCH reserved from the terminal 20A overlap at the terminal 20A.

As a method for improving the reliability and the delay performance, inter-terminal coordination is being studied. For example, an inter-terminal coordination method 1 and an inter-terminal coordination method 2 illustrated below are being studied. Hereinafter, the terminal 20 that transmits coordination information is referred to as UE-A, and the terminal 20 that receives coordination information is referred to as UE-B.

### Inter-Terminal Coordination Method 1):

For transmission of the UE-B, a preferred resource set and/or a non-preferred resource set is/are transmitted from the UE-A to the UE-B.

### Inter-Terminal Coordination Method 2):

In the resource indicated by the SCI received from the UE-B, the fact that a collision with other transmission or reception is expected, a collision is likely to occur, or a collision is detected is transmitted from the UE-A to the UE-B. The “resource set” may be replaced with the fact.

Further, for the inter-terminal coordination, techniques according to 1) through 6) described below may be determined, for example.

1) When and how the terminal 20A is to determine the content of the resource set. The UL scheduling may be taken into consideration.

2) When the terminal 20A is to notify the terminal 20B of the resource set, and which terminal 20 is to notify the resource set.

3) How to determine which terminal 20 is to notify which terminal 20 to be notified of the resource set.

4) How the terminal 20A is to notify the resource set. Which notification method is to be used, and whether the notification is to be made explicitly or implicitly.

5) When and how the terminal 20B is to receive or is not to receive the resource set. And when and how the terminal 20B is to reflect or is not to reflect the received resource set in the resource selection for the

6) How to define or not define the association between the support and signaling of the inter-terminal coordination and the cast type. transmission.

According to the inter-terminal coordination method 1), the UE-B may perform the operations illustrated in 1) through 4) below.

1) The resource of the UE-B used for the resource selection or resource reselection for the transmission may be determined based on both the sensing result of the UE-B and the coordination information received from the UE-A. The determination may be limited to the case where the sensing result of the UE-B is available, and determination may be made based solely on the coordination information received from the UE-A when the sensing result of the UE-B is not available.

2) The resource of the UE-B used for the resource selection or resource reselection for the transmission may be determined based solely on the coordination information received from the UE-A.

3) The resource of the UE-B to be reselected may be determined based on the coordination information received from the UE-A.

4) The resource of the UE-B used for the resource selection or resource reselection for the transmission may be determined based on the coordination information received from the UE-A.

According to the inter-terminal coordination method 2), the UE-B may perform operations illustrated in 1) and 2) below.

1) The UE-B may determine the resource to be reselected based on the coordination information received from the UE-A.

2) The UE-B may determine whether or not a retransmission is required based on the coordination information received from the UE-A.

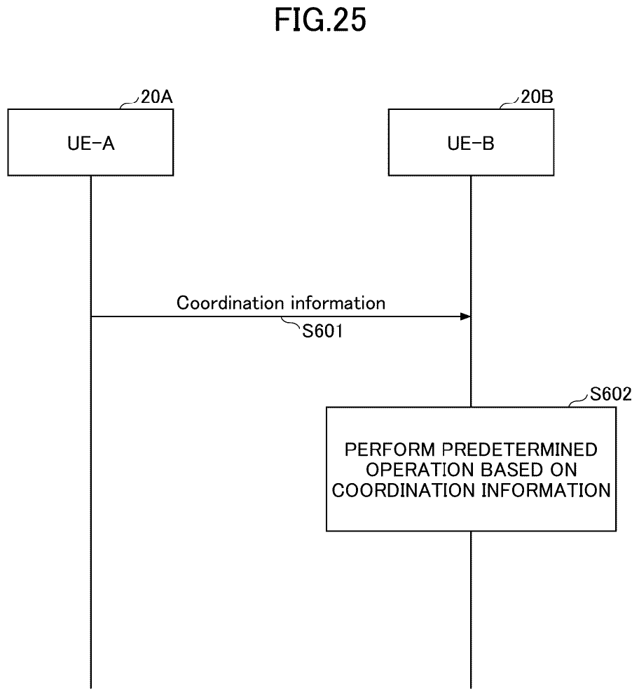

FIG. 25 is a sequence diagram for explaining an example of the inter-UE coordination. In step S601, the UE-A transmits the coordination information to the UE-B. In following step S602, the UE-B performs a predetermined operation based on the coordination information.

The NR sidelink supports a transmission mode in which the terminal autonomously determines the resource to be used for the transmission. The LTE sidelink also supports the transmission mode in which the terminal autonomously determines the resource to be used for the transmission. In this transmission mode, the terminals detect future resource use by decoding signals of each other and operate so as not to generate a collision. However, the NR sidelink and the LTE sidelink are defined as different signals, and it is not possible to detect each other and avoid the collision. For this reason, it is difficult for the NR sidelink and the LTE sidelink to share resources.

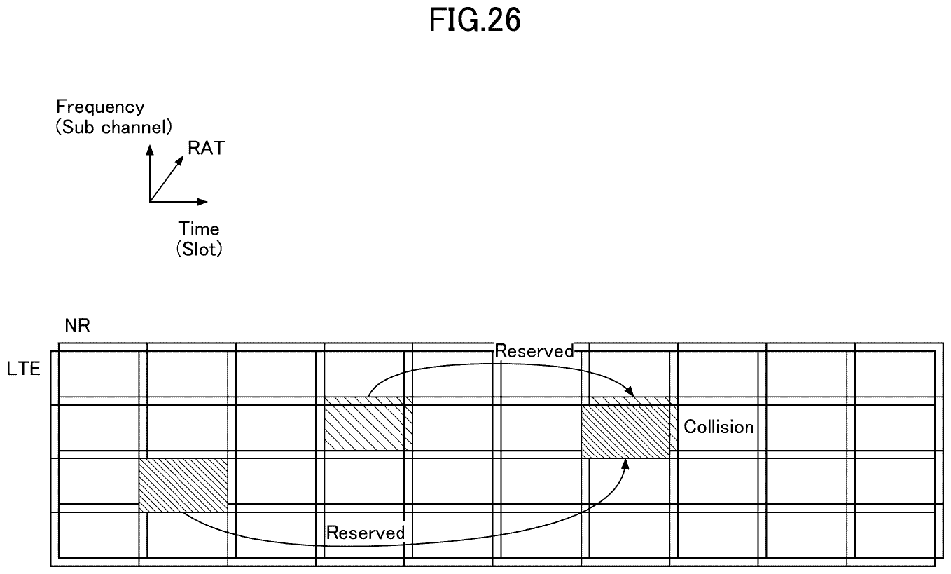

FIG. 26 is a diagram for explaining examples of NR-SL and LTE-SL. As illustrated in FIG. 26, in a case where the resources are shared between the NR-SL and the LTE-SL, the terminal 20 of the NR-SL cannot detect the reservation signal of the terminal 20 of the LTE-SL, and a collision of transmissions using the same time and same frequency resources may be expected. In order to avoid the collision, it was necessary for a network or a regulator to appropriately configure or determine the configuration in advance so that individual resources are used for the LTE-SL and the NR-SL. For example, it is necessary to prevent the resource pools of the LTE and the NR from including the same time/frequency resources.

However, in the world decision, the resources available to the cellular V2X are not abundant, and only a limited allocation is available. For this reason, the constraint that requires completely separate time/frequency resources to be used for the LTE-SL and the NR-SL is undesirable.

Accordingly, the UE (hereinafter referred to as UE-B) including a transmission and reception mechanism of the NR-SL may acquire information based on the resource reservation of the LTE-SL UE from an other UE (hereinafter referred to as UE-A). The resource reservation information of the LTE-SL UE may include a resource scheduled to be used for the transmission by the UE-A, and this resource may be limited to a reserved resource, or may include a selected resource that is not yet reserved.

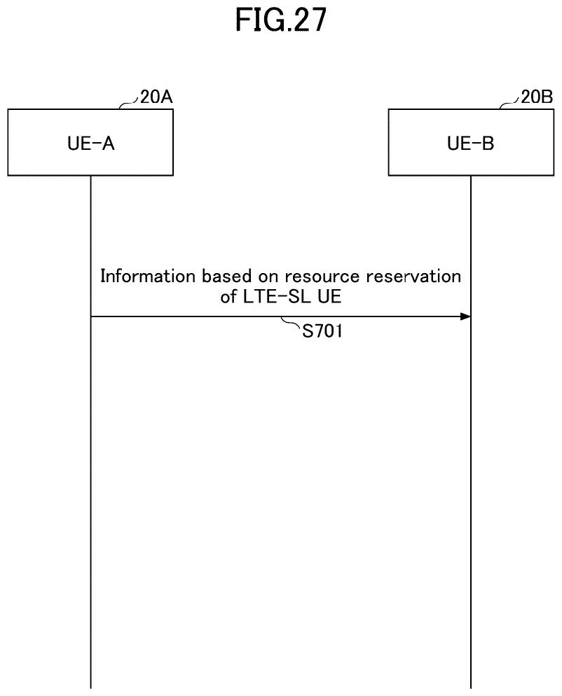

FIG. 27 illustrates an example of information sharing in the embodiment of the present invention. In step S701, the UE-A transmits information based on the resource reservation of the LTE-SL UE to the UE-B. The UE-B may receive the information from the UE-A via the NR-SL signal.

The terminal 20 may perform a resource identification operation related to resource selection of the NR-SL based on the acquired information, as illustrated in A) through G) below. The terminal 20 may perform a combination of a plurality of operations among A) through G). For example, the acquired information may be the RSRP detected in one or a plurality of resources in the LTE-SL. The LTE and the NR may be replaced with other different RATS.

A) Immediately before or immediately after the resource exclusion based on the resource reservation in the NR-SL is performed, the terminal 20 may perform the resource exclusion based on the acquired information.

According to the operation described above, it is possible to perform the resource exclusion of the LTE-SL by considering the RSRP, similar to the resource reservation of the NR-SL.

B) After the resource exclusion based on the resource reservation in the NR-SL is performed, and it is determined that there is a sufficient amount of candidate resources in the set S_{A} of available resource candidates and a change of the RSRP threshold value ends, the terminal 20 may perform the resource exclusion based on the acquired information.

According to the operation described above, by determining the RSRP threshold value used for the resource exclusion based on the resource reservation in the NR-SL regardless of the resource reservation of the LTE-SL, it is possible to avoid an excessive increase in the RSRP threshold value, and to avoid an increase in collision with the resource reservation of the NR-SL.

C) A value indicating the priority related to the reservation of the LTE-SL or the PPPP (ProSe Per-Packet Priority) may be treated as having the same value as a value indicating the priority of the NR-SL, or the association with the value indicating the priority of the NR-SL may be defined, configured, or configured in advance.

According to the operation described above, a simple terminal implementation or a flexible configuration can be achieved.

D) The RSRP threshold value for the resource exclusion based on the resource reservation of the LTE-SL may be the same as or different from the RSRP threshold value for the resource exclusion of the NR-SL, or may be configured in advance.

According to the operation described above, a simple terminal implementation or a flexible configuration can be achieved.

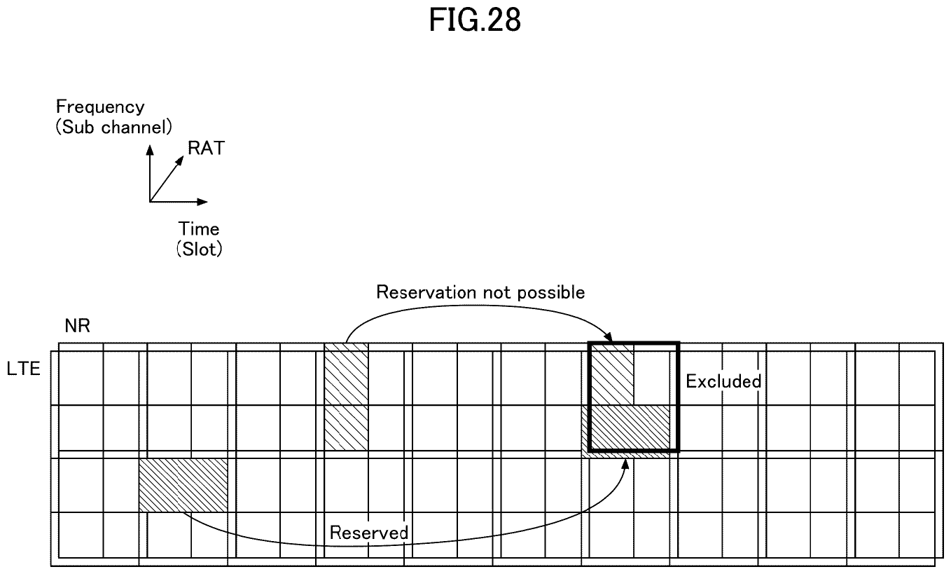

E) FIG. 28 is a diagram illustrating an example (1) of the resource exclusion in the embodiment of the present invention. As illustrated in FIG. 28, the resource exclusion operation may be performed in a case where at least some of the resources reserved in the LTE-SL overlaps at least some of the candidate resources of the NR-SL. The resource exclusive is also applicable to a case where the SCS is different between the LTE and the NR. For example, in a case where the SCS of the LTE-SL is SCS=15 kHz and the SCS of the NR-SL is different (for example, 30 kHz), and at least some of the symbols and/or at least some of the PRBs overlap, the slot and the sub channel in the NR-SL may be excluded from the set S_{A} of available resource candidates.

In addition, E) may be applied to a case where the time (for example, slot) and/or the frequency (for example, sub channel) for partitioning the NR-SL resource and the time (for example, slot) and/or the frequency (for example, sub channel) for partitioning the LTE-SL resource are not aligned.

According to the operation described above, the resource exclusion operation can be performed even in a case where the definition, the configuration, or the pre-configuration related to the time-frequency resource is different between the LTE-SL and the NR-SL.

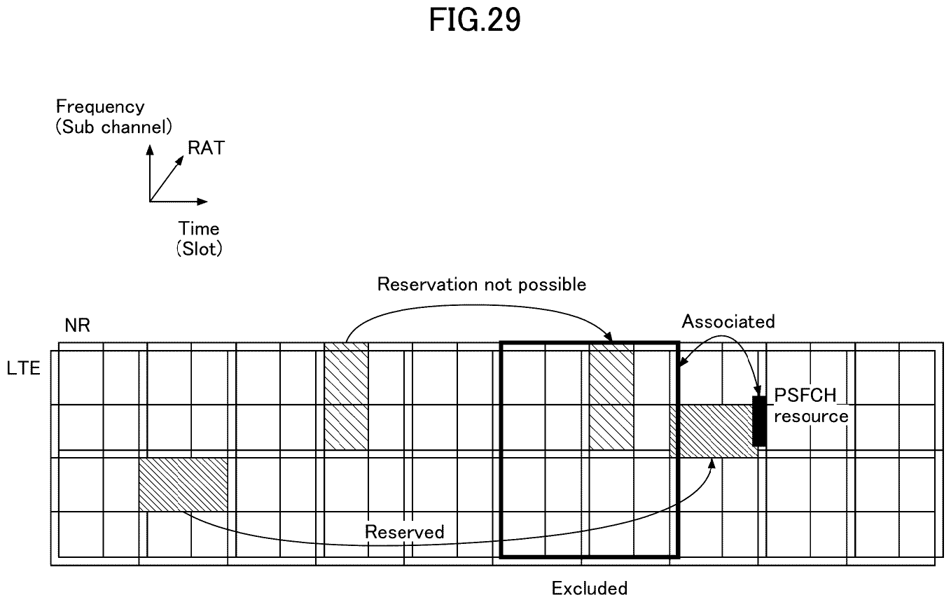

F) FIG. 29 is a diagram illustrating an example (2) of the resource exclusion in the embodiment of the present invention. As illustrated in FIG. 29, in a case where the resource reserved in the LTE-SL at least partially overlaps the PSFCH resource of the NR-SL, the PSCCH/PSSCH resource associated with the PSFCH may be excluded from the set S_{A} of available resource candidates. The priority of the NR-SL may be a priority related to transmission data. That is, the priority may be determined by the same method as the exclusion related to the overlap of the PSCCH/PSSCH resources. In addition, the priority of the NR-SL may be set to a predetermined priority. The predetermined priority may be a priority defined, configured or configured in advance for the operation of F). The RSRP threshold value of the NR-SL may be the same value as the exclusion related to the overlap of the PSCCH/PSSCH resources. Further, the RSRP threshold value of the NR-SL may be set to a predetermined value. The predetermined value may be a value defined, configured, or configured in advance for the operation of F).

According to the operation described above, it is possible to avoid the case where the corresponding PSFCH transmission and reception may fail due to the LTE-SL.

G) The terminal 20 may use information acquired until a timing that is a predetermined time earlier than a resource selection timing or a timing triggered from the higher layer. T^{SL}_{proc,0} (refer to Non-Patent Document 3), that is, a parameter related to the time from the tail of the sensing window to the timing described above may be applied. Moreover, T (refer to Non-Patent Document 4), that is, a parameter related to the time from the acquisition of information related to simultaneous LTE-SL/NR-SL transmission to the execution thereof, may be applied. Further, a parameter T′ defined for the operation of G) may be applied.

By the operation described above, the NR-SL terminal can perform the resource selection so as not to cause a collision with the transmission of the LTE-SL.

Further, the terminal 20 may perform an operation related to the re-evaluation of the NR-SL or the preemption check, based on the acquired information related to the resource reservation of the other terminal 20. The terminal 20 may perform any one of the operations of A) through G) illustrated above.

According to the operation described above, in a case where the reservation of the LTE-SL occurs after the resource selection of the NR-SL, the NR-SL terminal can operate so as not to cause a collision with the transmission of the LTE-SL.

In addition, the terminal 20 may transmit predetermined information with respect to the gNB 10, based on information related to a resource reservation of the other terminal 20. For example, the terminal 20 may perform operations, as illustrated in a) through e) below. The terminal 20 may perform a combination of a plurality of operations among a) through e). The acquired information may be information based on the resource reservation of the LTE-SL UE received from the UE-B.

a) In a case where the operation is performed as the NR Resource Allocation Mode 1, that is, during the operation of performing the SL transmission based on an instruction of the gNB 10, the terminal 20 may transmit predetermined information to the gNB 10 based on the acquired information.

b) In a case where the operation is performed as the LTE Resource Allocation Mode 3 or 4, that is, during the operation of performing the SL transmission based on the instruction of the gNB 10 or the operation of the terminal 20 autonomously determining the SL transmission resource, the terminal 20 may transmit the predetermined information to the gNB 10 based on the acquired information.

c) The terminal 20 may report the acquired information to the gNB 10. The terminal 20 may report the acquired information as the CSI, or may report the acquired information as higher layer information, or may report the acquired information by one of the PUCCH and the PUSCH.

d) The terminal 20 may transmit the HARQ-ACK to the gNB 10 based on the acquired information. For example, the terminal 20 may perform a collision determination based on the acquired information, and transmit NACK to the gNB in a case where the terminal 20 determines that a collision occurred. In a case where the terminal 20 determines based on the acquired information that the SL resource allocated to the gNB 10 is not available, the 10 terminal 20 may determine that the collision occurred. Further, in a case where the terminal 20 determines based on the acquired information that the PSFCH resource with respect to the resource allocated to the gNB 10 is not available, the terminal 20 may determine that the collision occurred. The determination described above may be performed based on any one of the operations of A) through G) described above. In a case where the priority and/or the RSRP related to the reservation of the LTE-SL with respect to the SL resource allocated from the gNB 10 satisfies a predetermined condition when performing the determination described above, the PSFCH resource may be determined as being not available. When a collision is determined during the determination described above, the SL transmission using the SL resource allocated from the gNB 10 does not need to be performed.

e) The terminal 20 may transmit a Scheduling Request (SR) to the gNB 10 based on the acquired information. For example, the terminal 20 may perform the collision determination based on the acquired information, and transmit the SR to the gNB 10 when it is determined that a collision occurred. In a case where the terminal 20 determines based on the acquired information that the SL resource allocated to the gNB 10 is not available, the terminal 20 may determine that the collision occurred. Further, in a case where the terminal 20 determines based on the acquired information that the PSFCH resource with respect to the resource allocated to the gNB 10 is not available, the terminal 20 may determine that the collision occurred. The determination described above may be performed based on any one of the operations of A) through G) described above. In a case where the priority and/or the RSRP related to the reservation of the LTE-SL with respect to the SL resource allocated from the gNB 10 satisfies a predetermined condition when performing the determination described above, the PSFCH resource may be determined as being not available. When a collision is determined during the determination described above, the SL transmission using the SL resource allocated from the gNB does not need to be performed. In the case where there 10 is no PUCCH resource for the HARQ-ACK transmission in the operation of d), the operation of e) may be applied.

According to the operation described above, it is possible to expect a network and/or UE operation that avoids the collision, by notifying the network of the reservation information of the LTE-SL and the collision information between the LTE-SL and the NR-SL.

In addition, the terminal 20 may perform the resource selection in the MAC layer of the NR-SL, based on the acquired information related to the resource reservation of the other terminal 20.

When performing the resource selection from the set S_{A} acquired from the PHY layer of the MAC layer, the terminal 20 may perform the resource selection after excluding the resource based on the acquired information.

For example, the set S_{A} acquired from the PHY layer may be determined without using the acquired information, or the set S_{A} may be determined by an operation similar to the case where there is only the NR-SL, or the set S_{A} may not be applied with the operations of A) through G) described above.

For example, the set S_{A} acquired from the PHY layer may be determined using the acquired information, or the set S_{A} may be applied with the operations of A) through G) described above.

The “resource based on information acquired from the UE-A” may be any one of resources 1) through 3) illustrated in the following.
1) The resource overlapping at least a part of the resources reserved in the LTE-SL as illustrated in G) above.
2) The resource corresponding to the PSFCH when the PSFCH overlaps at least a part of the resources reserved in the LTE-SL as illustrated in H) above.
3) The resource based on the information acquired until the timing that is the predetermined time earlier than the resource selection timing or the timing triggered from the higher layer as illustrated in G) above.

Whether or not the resource corresponds to the “resource based on information acquired from the UE-A” (that is, whether or not the resource is to be excluded from the selection target) may be determined based on the value indicating the priority (or PPPP) related to the reservation of the LTE-SL and/or the RSRP. The details of the priority may be defined in a manner similar to that described in C) above.

For example, in a case where the value indicating the priority related to the reservation of the LTE-SL is smaller than the value indicating the priority of the data to be transmitted or the threshold value corresponding to the data to be transmitted (that is, in the case where the priority is high), the resource may be excluded from the selection target. On the other hand, in a case where the value indicating the priority related to the reservation of the LTE-SL is larger than the value indicating the priority of the data to be transmitted or the threshold value corresponding to the data to be transmitted (that is, in the case where the priority is low), the resource does not need to be excluded from the selection target.

For example, in a case where the RSRP related to the reservation of the LTE-SL is larger than the threshold value of the RSRP corresponding to the value indicating the priority of the data to be transmitted and/or the value indicating the priority related to the reservation of the LTE-SL, the resource may be excluded from the selection target. On the other hand, in a case where the RSRP related to the reservation of the LTE-SL is smaller than the threshold value of the RSRP corresponding to the value indicating the priority of the data to be transmitted and/or the value indicating the priority related to the reservation of the LTE-SL, the resource does not need to be excluded from the selection target. The details of the threshold value of the RSRP may be defined in a manner similar to that described in D) above.

In addition, when resource selection is performed from the set S_{A} acquired from the PHY layer, the operation of performing the resource selection after excluding the resource based on the information acquired from the UE-A may be applied to an operation related to the re-evaluation or the preemption check. In a case where the already selected resource or the already reserved resource, that is, the target resource of the re-evaluation or the preemption check is the “resource based on information acquired from the UE-A” described above, the re-evaluation or the preemption may be determined and the resource reselection may be performed, without requesting the PHY layer to perform the re-evaluation or the preemption check. By operating as described above, the PHY operation can be made the same as the conventional operation, and the PHY configuration can be simplified. In addition, the NR-SL terminal can perform the resource selection so as not to cause a collision with transmission of the LTE-SL.

Moreover, when the terminal 20 performs the resource selection from the set S_{A} acquired from the PHY layer, the terminal 20 may preferentially select the resource other than the resource based on the information acquired from the UE-A.

For example, when performing the resource selection from the set S_{A} acquired from the PHY layer, in the case where the terminal 20 preferentially selects the resource other than the resource based on the information acquired from the UE-A, the terminal 20 may perform the resource selection after excluding the resource based on the information acquired from the UE-A when performing the resource selection from the set S_{A} acquired from the PHY layer as described above. The operation of excluding the resource may be replaced with an operation of lowering the priority of the resource. By operating as described above, the PHY operation can be the same as the conventional operation, and the PHY configuration can be simplified.

For example, the PHY layer may report both a set S_{A1} determined without using the information acquired from the UE-A and a set S_{A2} determined using the information acquired from the UE-A. The MAC layer may preferentially select the resource from the set S_{A2}, and may select the resources from the set S_{A1} when the resource cannot be selected from the set S_{A2}. By operating as described above, in a case where it is difficult to perform the transmission of the NR-SL using the information acquired from the UE-A, an exception processing can be applied. In the case where it is difficult to perform the transmission of the NR-SL using the information acquired from the UE-A, the transmission of the NR-SL can be prioritized.

Further, the PHY layer may determine the set S_{A} using the information acquired from the UE-A and report the set S_{A} to the MAC layer in a case where a predetermined condition is satisfied, and may determine the set S_{A} without using the information acquired from the UE-A and report the set S_{A} to the MAC layer in a case where the predetermined condition is not satisfied. The MAC layer may select the resource from the set S_{A} reported from the PHY layer.

The predetermined condition may be that the RSRP threshold value for excluding the resource during the resource allocation operation is a predetermined value or less. The RSRP threshold value may be a threshold value for increasing by 3 dB in a case where the number of resource candidates remaining in the procedure of determining the set S_{A} is less than a predetermined value (refer to Non-Patent Document 3). That is, in the case where the RSRP threshold value is the predetermined value or less, the resource identification may be performed using the information acquired from the UE-A, and in the case where the RSRP threshold value exceeds the predetermined value, the resource identification may be performed without using the information acquired from the UE-A. In addition, the RSRP threshold value may be an RSRP threshold value at the time when the set S_{A} to be reported to the MAC layer is determined in the procedure of determining the set S_{A}.

In a case where it is difficult to perform the transmission of the NR-SL using the information acquired from the UE-A when operating as described above, the exception processing can be applied. In the case where it is difficult to perform the transmission of the NR-SL using the information acquired from the UE-A, the transmission of the NR-SL can be prioritized.

By operating as described above, the NR-SL terminal can select the resource so as not to cause a collision with the transmission of the LTE-SL.

Moreover, the transmission and reception of the information based on the resource reservation of the LTE-SL may be performed based on the operation of the inter-terminal coordination method 1) described above.

The UE-B may transmit a signal requesting transmission of the information based on the reservation of the LTE-SL, with respect to the UE-A. This signal may be a signal based on a request signal of the inter-terminal coordination method 1). The request signal may notify whether or not the information based on the reservation of the LTE-SL is requested.

The UE-A may transmit the reservation information of the LTE-SL to the UE-B.

The UE-A may determine a preferred resource set and/or a non-preferred resource set, based on the reservation information of the LTE-SL, and notify the UE-B of the determined resource set.

In the resource determination operation of the inter-terminal coordination method 1), the UE-A may exclude the resource corresponding to the LTE-SL reservation information from the preferred resources or may include the resource corresponding to the LTE-SL reservation information in the non-preferred resources. In the resource determining operation of the inter-terminal coordination manner 1), whether or not the operation based on the LTE-SL reservation information is to be performed may be determined by configuration or pre-configuration, or may be determined based on the UE capability of the UE-A and/or the UE-B, or may be determined based on the requirement of the UE-B, or may be determined by the UE-A implementation.

By the operation described above, it is possible to perform an operation which takes into consideration the reservation of the LTE-SL by reusing the existing mechanism. That is, it is possible to simplify the UE configuration.

The embodiment described above is not limited to the coexistence or coordination operation of the LTE-SL and the NR-SL, and may be applied to the coexistence or coordination operation of multiple RATs.

In the embodiment described above, the operation of considering the reservation on the LTE-SL side on the NR-SL side is described as an example, however, an operation in the opposite direction of considering the reservation on the NR-SL side on the LTE-SL side may be performed, or an operation of considering the reservation in both directions may be performed. In addition, in the embodiment described above, the UE-B may perform an operation by recognizing whether or not the information received from the UE-A is the information determined based on the reservation of the LTE-SL, or may perform the operation without recognizing the above information. The UE-A may notify the UE-B of whether or not the information is determined based on the reservation of the LTE-SL.

The embodiment described above is not limited to V2X terminals, and may be applied to terminals that perform D2D communication.

The operation according to the embodiment described above may be performed only in a specific resource pool. For example, the operation may be performed only in the resource pool available to the terminal 20 of Release 17 or successor Releases.

In the embodiment described above, the terminal 20 may acquire the resource reservation information in the LTE-SL, and apply the resource reservation information to the resource identification in the NR-SL, so as to improve the reliability of resource selection, and share the resource between the LTE-SL and the NR-SL.

That is, the resource may be shared by the inter-terminal direct communication using different Radio Access Technologies (RATs).

### (Device Configuration)

Next, a functional configuration example of the base station 10 and the terminal 20 for performing the above noted processes and operations will be described. The base station 10 and terminal 20 include functions for implementing the embodiment described above. However, each of the base station 10 and the terminal 20 may include only a part of the functions of the embodiment.

### <Base Station 10>

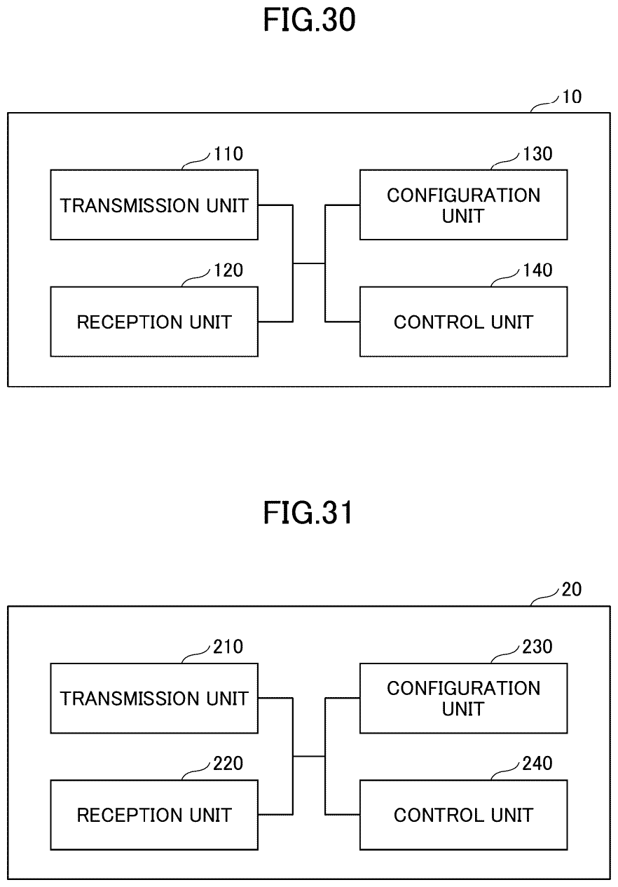

FIG. 30 is a diagram illustrating an example of the functional configuration of the base station 10. As illustrated in FIG. 30, the base station 10 includes a transmission unit 110, a reception unit 120, a configuration unit 130, and a control unit 140. The functional configuration illustrated in FIG. 30 is merely an example. Functional divisions and names of the functional units may be arbitrary as long as the operations according to the embodiment of the present invention can be performed.

The transmission unit 110 includes functions for generating a signal to be transmitted to the terminal 20, and wirelessly transmitting the signal. The reception unit 120 includes functions for receiving various signals transmitted from the terminal 20, and acquiring information of a higher layer from the received signals, for example. In addition, the transmission unit 110 includes functions for transmitting NR-PSS, NR-SSS, NR-PBCH, DL/UL control signals, DL data, and the like to the terminal 20.

The configuration unit 130 stores pre-configured configuration information and various configuration information to be transmitted to the terminal 20 in a storage device, and reads the stored configuration information from the storage device, as required. A content of the configuration information includes information and the like related to the configuration of the D2D communication, for example.

As described in the embodiment, the control unit 140 performs processing related to configuration for the terminals 20 to perform D2D communication. In addition, the control unit 140 transmits the scheduling of the D2D communication and the DL communication to the terminal 20 via the transmission unit 110. Moreover, the control unit 140 receives the information related to the HARQ response of the D2D communication and the DL communication from the terminal 20 via the reception unit 120. The functional unit related to signal transmission in the control unit 140 may be included in the transmission unit 110, and the functional unit related to signal reception in the control unit 140 may be included in the reception unit 120.

### <Terminal 20>

FIG. 31 is a diagram illustrating an example of a functional configuration of the terminal 20. As illustrated in FIG. 31, the terminal 20 includes a transmission unit 210, a reception unit 220, a configuration unit 230, and a control unit 240. The functional configuration illustrated in FIG. 31 is merely an example. The functional sections and the names of the functional units may be any as long as the operations according to the embodiment of the present invention can be performed.

The transmission unit 210 creates a transmission signal from the transmission data and wirelessly transmits the transmission signal. The reception unit 220 wirelessly receives various signals, and acquires a signal of a higher layer from the received signal of the physical layer. Also, the reception unit 220 has a function of receiving the NR-PSS, NR-SSS, NR-PBCH, DL/UL/SL control signals, reference signals, and the like transmitted from the base station 10. For example, the transmission unit 210 transmits a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and the like to other terminals 20 as the D2D communication, and the reception unit 220 receives the PSCCH, the PSSCH, the PSDCH, the PSBCH, and the like from other terminals 20.

The configuration unit 230 stores various types of configuration information received from the base station 10 or the terminal 20 by the reception unit 220 in the storage device, and reads the configuration information from the storage device, as required. In addition, the configuration unit 230 also stores preconfigured configuration information. The content of the configuration information includes information related to the configuration of the D2D communication and the like, for example.

As described in the embodiment, the control unit 240 controls the D2D communication for establishing the RRC connection with the other terminals 20. In addition, the control unit 240 performs processing related to the power saving operation. Moreover, the control unit 240 performs processing related to the HARQ of the D2D communication and the DL communication. Further, the control unit 240 transmits information related to the HARQ responses of the D2D communication and the DL communication to other terminals 20 scheduled by the base station 10 to the base station 10. The control unit 240 may schedule the D2D communication of other terminals 20. In addition, the control unit 240 may autonomously select the resource to be used for the D2D communication from the resource selection window based on the sensing result, or may perform the re-evaluation or preemption. The control unit 240 also performs processing related to the power saving in transmission and reception of the D2D communication. The control unit 240 performs processing related to the inter-terminal coordination of the D2D communication. The functional unit related to the signal transmission in the control unit 240 may be included in the transmission unit 210, and the functional unit related to the signal reception in the control unit 240 may be included in the reception unit 220.

### (Hardware Configuration)

The block diagrams (FIG. 30 and FIG. 31) used for describing the embodiment illustrate blocks in functional units. These functional blocks (function units) can be implemented by an arbitrary combination of hardware and/or software. Further, means for implementing each functional block is not particularly limited. In other words, each functional block may be implemented by a single apparatus in which multiple elements are physically and/or logically coupled, or may be implemented by two or more apparatuses that are physically and/or logically separated and are directly or indirectly connected (using wired, wireless, and the like, for example). The functional blocks may be implemented by the single apparatus or the two or more apparatuses described above in combination with software.

Functions include, but are not limited to, judging, determining, assessing, calculating, computing, processing, deriving, investigating, searching, checking, receiving, transmitting, outputting, accessing, resolving, selecting, planning, establishing, comparing, assuming, expecting, deeming, broadcasting, notifying, communicating, forwarding, configuring, reconfiguring, allocating, mapping, assigning, and the like. For example, a functional block (component) that performs a transmitting function is referred to as a transmitting unit or a transmitter. In either case, the implementation method is not particularly limited, as described above.

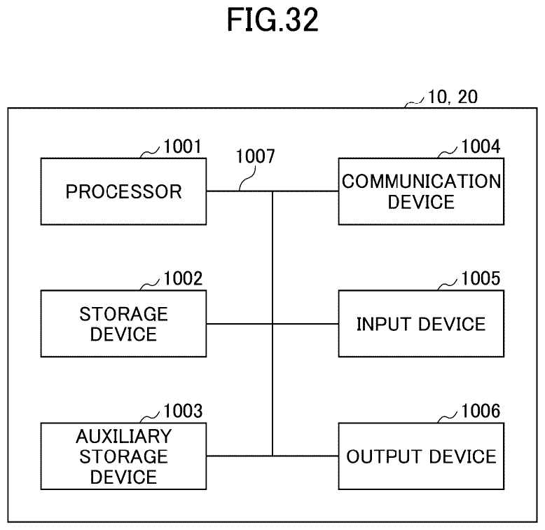

For example, the base station 10, terminal 20, and the like according to the embodiment of the present disclosure may function as a computer for performing processes of the wireless communication method of the present disclosure. FIG. 32 is a diagram illustrating an example of hardware structures of the base station 10 and terminal 20 according to the embodiment of the present disclosure. The base station 10 and the terminal 20 described above may physically be configured by a computer apparatus including a processor 1001, a storage device 1002, an auxiliary storage device 1003, a communication device 1004, an input device 1005, an output device 1006, a bus 1007, and the like.

It should be noted that, in the following description, the term “apparatus” can be replaced with a circuit, a device, a unit, and the like. The hardware structures of the base station 10 and terminal 20 may be configured to include one or more apparatuses illustrated in the figure, or may be configured not to include some of the apparatuses.

Each function of the base station 10 and terminal 20 can be implemented by causing predetermined software (programs) to be read onto a hardware element, such as the processor 1001, the storage device 1002, and the like to perform operations by the processor 1001, and control the communication performed by the communication device 1004 and control reading and/or writing of data with respect to the storage device 1002 and the auxiliary storage device 1003.

The processor 1001 controls the entire computer by controlling an operating system, for example. The processor 1001 may be configured by a Central Processing Unit (CPU) including an interface with a peripheral apparatus, a control apparatus, a calculation apparatus, a register, and the like. For example, the control unit 140, the control unit 240, and the like described above may be implemented by the processor 1001.

Further, the processor 1001 reads out onto the storage device 1002 a program (program code), a software module, data, and the like from the auxiliary storage device 1003 and/or the communication device 1004, and performs various processes according to the read program, software module, data, and the like. The program in this case is a program that causes the computer to perform at least some of the operations according to the embodiment described above. For example, the control unit 140 of the base station 10 illustrated in FIG. 30 may be implemented by a control program stored in the storage device 1002 and executed by the processor 1001. For example, the control unit 240 of the terminal 20 illustrated in FIG. 31 may be implemented by a control program stored in the storage device 1002 and executed by the processor 1001. The various processes are performed by a single processor 1001 in the example described above, however, the processes may be performed simultaneously or sequentially by two or more processors 1001. The processor 1001 may be implemented by one or more chips. The program may be transmitted from a network via a telecommunication line.

The storage device 1002 is a computer-readable recording medium, and may be configured by at least one medium selected from a Read Only Memory (ROM), an Erasable Programmable ROM (EPROM), an Electrically Erasable Programmable ROM (EEPROM), a Random Access Memory (RAM), and the like, for example. The storage device 1002 may be referred to as a register, a cache, a main memory, and the like. The storage device 1002 is capable of storing programs (program codes), software modules, and the like that are executable by the computer to perform the communication process according to the embodiment of the present disclosure.

The auxiliary storage device 1003 is a computer-readable recording medium, and may be configured by at least one medium selected from an optical disk, such as a Compact Disc ROM (CD-ROM) and the like, a hard disk drive, a flexible disk, a magneto optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, and the like, for example. The storage medium may be a database including the storage device 1002 and/or the auxiliary storage device 1003, a server, or any other appropriate medium, for example.

The communication device 1004 is a hardware element (transmission and reception device) for performing a communication between computers via a wired network and/or a wireless network, and may be referred to as a network device, a network controller, a network card, a communication module, and the like, for example. The communication device 1004 may be configured to include a high frequency switch, a duplexer, a filter, a frequency synthesizer, and the like to implement a Frequency Division Duplex (FDD) and/or a Time Division Duplex (TDD), for example. For example, a transmitting and receiving antenna, an amplifier unit, a transmitting and receiving unit, a transmission line interface, and the like may be implemented by the communication device 1004. The transmitting and receiving unit may be physically or logically divided into a transmitting unit and a receiving unit.

The input device 1005 is an input device (for example, a keyboard, a mouse, a microphone, a switch, a button, a sensor, and the like) that receives an external input. The output device 1006 is an output device (for example, a display, a speaker, an LED lamp, and the like) that makes an output to the outside. The input device 1005 and the output device 1006 may be integrated into a single device (for example, a touchscreen panel).

In addition, the apparatuses, such as the processor 1001, the storage device 1002, and the like are connected to one another via the bus 1007 used for communication of information. The bus 1007 may be configured using a single bus, or may be configured using different buses between the apparatuses.

Further, each of the base station 10 and terminal 20 may be configured to include a hardware element, such as a microprocessor, a Digital Signal Processor (DSP), an Application Specific Integrated Circuit (ASIC), a Programmable Logic Device (PLD), a Field Programmable Gate Array (FPGA), and the like, and a part or all of each functional block may be implemented by the hardware element. For example, the processor 1001 may be implemented by at least one of the hardware elements described above.

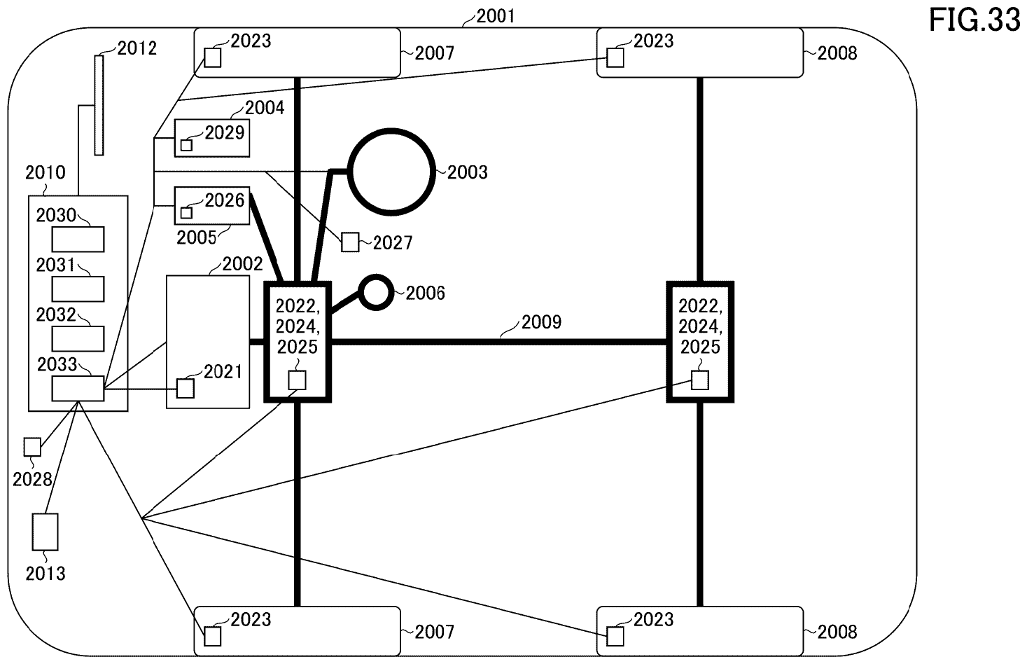

FIG. 33 illustrates an example of a configuration of a vehicle 2001. As illustrated in FIG. 33, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 through 2029, an information service unit 2012, and a communication module 2013. The aspects/embodiments described in the present disclosure may be applied to a communication device installed in the vehicle 2001, and may be applied to the communication module 2013, for example.

The drive unit 2002 may be configured to include an engine, a motor, and a hybrid of an engine and a motor, for example. The steering unit 2003 includes at least a steering wheel (also called a handle), and is configured to steer the front wheels and/or the rear wheels based on the operation of the steering wheel operated by the user.

The electronic control unit 2010 is configured to include a microprocessor 2031, a memory (ROM, RAM) 2032, and a communication port (IO port) 2033. The electronic control unit 2010 receives signals from the various sensors 2021 through 2029 provided in the vehicle 2001. The electronic control unit 2010 may be referred to as an Electronic Control Unit (ECU).

The signals from the various sensors 2021 through 2029 include a current signal from the current sensor 2021 which senses a motor current, a front or rear wheel rotation speed signal acquired by the rotation speed sensor 2022, a front or rear wheel pneumatic signal acquired by the pneumatic sensor 2023, a vehicle speed signal acquired by the vehicle speed sensor 2024, an acceleration signal acquired by the acceleration sensor 2025, an accelerator pedal depression amount signal acquired by the accelerator pedal sensor 2029, a brake pedal depression amount signal acquired by the brake pedal sensor 2026, an operation signal of a shift lever acquired by the shift lever sensor 2027, and a detection signal acquired by the object detection sensor 2028 for detecting an obstacle, a vehicle, a pedestrian, and the like.

The information service unit 2012 is configured to include various devices, such as a car navigation system, an audio system, a speaker, a television, and a radio for providing (outputting) various kinds of information, such as driving information, traffic information, entertainment information, and the like, and one or more ECUs for controlling the various devices. The information service unit 2012 provides various types of multimedia information and multimedia services to an occupant of the vehicle 2001, by utilizing information acquired from an external device via the communication module 2013 and the like. The information service unit 2012 may include an input device (for example, a keyboard, a mouse, a microphone, a switch, a button, a sensor, a touchscreen panel, and the like) that receives an input from the outside, and may include an output device (for example, a display, a speaker, an LED lamp, a touchscreen panel, and the like) that makes an output to the outside.

A driving support system unit 2030 is configured to include various devices, such as a millimeter wave radar, a Light Detection and Ranging (LiDAR), a camera, a positioning locator (for example, GNSS and the like), map information (for example, a High Definition (HD) map, an Autonomous Vehicle (AV) map, and the like), a gyro system (for example, an Inertial Measurement Unit (IMU)), an Inertial Navigation System (INS)), and the like), an Artificial Intelligence (AI) chip, and an AI processor for providing functions to prevent accidents and reduce a driving load on a driver, and one or more ECUs for controlling the various devices. In addition, the driving support system unit 2030 transmits and receives various types of information via the communication module 2013 to implement a driving support function or an autonomous driving function.

The communication module 2013 may communicate with the microprocessor 2031 and constituent elements of the vehicle 2001 via a communication port. For example, the communication module 2013 transmits data to and receives data from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and the sensors 2021 through 2029 provided in the vehicle 2001, via the communication port 2033.

The communication module 2013 is a communication device that is controllable by the microprocessor 2031 of the electronic control unit 2010 and is capable of communicating with the external device. For example, various kinds of information are transmitted to and received from external devices through wireless communication. The communication module 2013 may be provided inside or outside the electronic control unit 2010. The external device may include a base station, a mobile station, and the like, for example.

The communication module 2013 may transmit at least one of signals from the various sensors 2021 through 2028 described above input to the electronic control unit 2010, information obtained based on these signals, and information based on the input from the outside (user) obtained via the information service unit 2012, to an external device via wireless communication. The electronic control unit 2010, the various sensors 2021 through 2028, the information service unit 2012, and the like may be referred to as an input unit that receives an input. For example, the PUSCH transmitted by the communication module 2013 may include information based on the input.

The communication module 2013 receives various kinds of information (traffic information, signal information, inter-vehicle information, and the like) transmitted from an external device, and displays the information on the information service unit 2012 provided in the vehicle 2001. The information service unit 2012 may be referred to as an output unit that outputs information (for example, outputs information to a device, such as a display, a speaker, and the like based on the PDSCH (or data/information decoded from the PDSCH) received by the communication module 2013). The communication module 2013 stores various kinds of information received from the external device in the memory 2032 that can be used by the microprocessor 2031. The microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 through 2029, and the like provided in the vehicle 2001 based on the information stored in the memory 2032.

### SUMMARY OF EMBODIMENTS

As described above, according to the embodiments of the present invention, there is provided a terminal including a communication unit configured to perform transmission and reception of a first Radio Access Technology (RAT), and a control unit configured to control communication of the first RAT, wherein the communication unit receives information related to a resource reservation of a second RAT from an other terminal, the control unit performs at least one of an operation of determining a resource set of the first RAT available in a physical layer and an operation of selecting a resource from the resource set in a Medium Access Control (MAC) layer, based on the information related to the resource reservation, and the communication unit performs a transmission to the other terminal using the selected resource.

With the above configuration, the terminal 20 can acquire the resource reservation information of the LTE-SL, and apply the resource reservation information to the resource identification in the NR-SL, and improve the reliability of the resource selection and share the resources between the LTE-SL and the NR-SL. That is, it is possible to share resources between D2D direct communications using different Radio Access Technologies (RATs).

The control unit may exclude a resource from the resource set based on the information related to the resource reservation of the MAC layer. With this configuration, the terminal 20 can acquire the resource reservation information of the LTE-SL and apply the resource reservation information to the resource exclusion of the NR-SL, and improve the reliability of the resource selection and to share the resources between the LTE-SL and the NR-SL.

The communication unit may report the information related to the resource reservation to a base station. With this configuration, the terminal 20 can acquire the resource reservation information of the LTE-SL and apply the resource reservation information to the resource exclusion of the NR-SL, and improve the reliability of the resource selection and share the resources between the LTE-SL and the NR-SL.

The communication unit may transmit a signal for requesting the information related to the resource reservation to the other terminal. With this configuration, the terminal 20 can acquire the resource reservation information of the LTE-SL and apply the resource reservation information to the resource exclusion in the NR-SL, and improve the reliability of the resource selection and share the resources between the LTE-SL and the NR-SL.

The control unit may determine a preferred resource or a non-preferred resource in an inter-terminal coordination operation, from the information related to the resource reservation. With this configuration, the terminal 20 can acquire the resource reservation information of the LTE-SL and apply the resource reservation information to the resource exclusion of the NR-SL, and improve the reliability of the resource selection and share the resources between the LTE-SL and the NR-SL.

In addition, according to the embodiments of the present invention, there is provided a communication method in which a terminal executes a process comprising a communication procedure performing transmission and reception of a first Radio Access Technology (RAT), a control procedure controlling communication of the first RAT, a procedure receiving information related to a resource reservation of a second RAT from an other terminal, a procedure performing at least one of an operation of determining a resource set of the first RAT available in a physical layer and an operation of selecting a resource from the resource set in a Medium Access Control (MAC) layer, based on the information related to the resource reservation, and a procedure performing a transmission to the other terminal using the selected resource.

With the above configuration, the terminal 20 can acquire the resource reservation information of the LTE-SL, and apply the resource reservation information to the resource identification in the NR-SL, and improve the reliability of the resource selection and share the resources between the LTE-SL and the NR-SL. That is, it is possible to share resources between D2D direct communications using different Radio Access Technologies (RATs).

### Supplement to Embodiments

The embodiments of the present invention are described above, however, the disclosed invention is not limited to the described embodiments, and a person skilled in the art would understand that various modifications, variations, alternatives, replacements, and the like of the embodiments are possible. In order to facilitate understanding of the present invention, specific values are used in the description, however, unless otherwise specified, the specific values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and the flow charts described in the embodiments of the present invention may be changed as long as there is no contradiction. For the sake of convenience of description, the base station 10 and the terminal 20 are described using functional block diagrams. However, the apparatuses may be realized by hardware, software, or a combination of hardware and software. The software executed by a processor included in the base station 10 according to the embodiment of the present invention and the software executed by a processor included in the terminal 20 according to the embodiment of the present invention may be stored in a Random Access Memory (RAM), a flash memory, a Read Only Memory (ROM), an EPROM, an EEPROM, a register, a Hard Disk Drive (HDD), a removable disk, a CD-ROM, a database, a server, or any other appropriate recording medium.

Further, indication of information may be performed not only by methods described in an aspect/embodiment of the present specification but also by a method other than those described in an aspect/embodiment of the present specification. For example, the information transmission may be performed by physical layer signaling (for example, Downlink Control Information (DCI), Uplink Control Information (UCI)), upper layer signaling (for example, Radio Resource Control (RRC) signaling, Medium Access Control (MAC) signaling, broadcast information (Master Information Block (MIB), System Information Block (SIB))), other signals, or combinations thereof. Further, RRC signaling may be referred to as an RRC message. The RRC signaling may be an RRC connection setup message, an RRC connection reconfiguration message, and the like, for example.

Each aspect/embodiment described in the present disclosure may be applied to at least one of a system using Long Term Evolution (LTE), LTE-Advanced (LTE-A), SUPER 3G, IMT-Advanced, 4th Generation mobile communication system (4G), 5th Generation mobile communication system (5G), 6th Generation mobile communication system (6G), xth Generation mobile communication system (xG) (xG (x is, for example, an integer, decimal)), Future Radio Access (FRA), New Radio (NR), New Radio Access (NX), Future Generation Radio Access (FX), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-Wide Band (UWB), Bluetooth (registered trademark), and other appropriate systems, and a next generation system enhanced, modified, developed, or defined therefrom. Further, multiple systems may also be applied in combination (for example, at least one of LTE and LTE-A combined with 5G, and the like).

The order of processing steps, sequences, flow charts and the like of an aspect/embodiment described in the present specification may be changed as long as there is no contradiction. For example, in a method described in the present disclosure, elements of various steps are presented in an exemplary order, and the order is not limited to the specific order presented.

The particular operations, that are described as being performed by the base station 10 in the present specification, may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above case, a single network node other than the base station 10 is provided in the described example, however, a combination of multiple other network nodes (for example, MME and S-GW) may be provided.

The information or signals and the like described in the present disclosure may be output from a higher layer (or lower layer) to a lower layer (or higher layer). The information or signals may be input or output through multiple network nodes.

The input or output information and the like may be stored at a specific location (for example, memory) or managed using a management table. The input or output information and the like may be overwritten, updated, or added. The information and the like that is output may be deleted. The information and the like that is input may be transmitted to another apparatus.

A decision or a determination in the embodiment of the present invention may be realized by a value (0 or 1) represented by one bit, by a Boolean value (true or false), or by comparison of numerical values (for example, comparison with a predetermined value).

Software should be broadly interpreted to mean, whether referred to as software, firmware, middle-ware, microcode, hardware description language, or by any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, Digital Subscriber Line (DSL) and the like) and wireless technologies (infrared, microwave, and the like), at least one of these wired line technologies and wireless technologies is included within the definition of the transmission medium.

Information, a signal, and the like described in the present disclosure may be represented using any one of various different technologies. For example, data, an instruction, a command, information, a signal, a bit, a symbol, a chip, and the like, described throughout the description above, may be represented by a voltage, an electric current, electromagnetic waves, magnetic fields, a magnetic particle, optical fields, a photon, or a combination thereof.

It should be noted that a term used in the present disclosure and/or a term required for understanding of the present specification may be replaced with a term having the same or similar meaning. For example, a channel and/or a symbol may be a signal (signaling). Further, a signal may be a message. Further, the Component Carrier (CC) may be referred to as a carrier frequency, cell, frequency carrier, and the like.

The terms “system” and “network” as used in the present disclosure may be used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used in any limiting way. Further, the mathematical formulas and the like that use these parameters may differ from those explicitly disclosed in the present disclosure. Because the various channels (for example, PUCCH, PDCCH, and the like) and information elements may be identified by any suitable names, the various names assigned to these various channels and information elements are not used in any limiting way.

In the present disclosure, the terms “BS: base station”, “radio base station”, “base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like, may be used interchangeably. The base station may be referred to as a macro-cell, a small cell, a femtocell, a picocell, and the like.

The base station may accommodate one or more (for example, three) cells. In the case where the base station accommodates a plurality of cells, the entire coverage area of the base station may be divided into a plurality of smaller areas, each smaller area may provide communication services by means of a base station subsystem (for example, an indoor small base station (Remote Radio Head (RRH). The term “cell” or “sector” refers to a part or all of the coverage area of at least one of the base station and base station subsystem that provides the communication services at the coverage.

In the present disclosure, the transmission of information from the base station to the terminal may be replaced with the base station instructing the terminal to perform control and operation based on the information.

In the present disclosure, terms such as “Mobile Station (MS)”, “user terminal”, “User Equipment (UE)”, “terminal”, and the like may be used interchangeably.

In some cases, the mobile station may be referred to by a person skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station and the mobile station may be referred to as a transmission apparatus, reception apparatus, communication apparatus, and the like.

The at least one of the base station and the mobile station may be a device installed in a mobile body, the mobile body itself, and the like. The mobile body is a movable object, and a moving speed is arbitrary. The mobile body may of course be stationary. Examples of the mobile body include, but are not limited to, vehicles, transportation vehicles, automobiles, motorcycles, bicycles, connected cars, excavators, bulldozers, wheel loaders, dump trucks, forklifts, trains, buses, hand carts, rickshaws, ships and other watercrafts, airplanes, rockets, satellites, drones (registered trademark), multicopters, quadcopters, balloons, and objects mounted thereon. The mobile body may be a moving object that travels autonomously based on an operation command. The mobile body may be a vehicle (for example, an automobile, an airplane, and the like), an unmanned moving object (for example, a drone, a self-driving vehicle, and the like), or a robot (manned or unmanned). At least one of the base station and the mobile station includes a device that does not necessarily move during the communication operation. For example, at least one of the base station and the mobile station may be an Internet of Things (IoT) sensor and the like.

Further, the base station in the present disclosure may be replaced with the user terminal. For example, each aspect/embodiment of the present disclosure may be applied to a configuration in which the communication between the base station and the user terminal is replaced with the communication between multiple terminals 20 (may be referred to as Device-to-Device (D2D), Vehicle-to-Everything (V2X), and the like, for example). In this case, the terminal 20 may be configured to include the functions of the base station 10 described above. Further, the terms “up” and “down” may also be replaced with a term (for example, “side”) corresponding to terminal-to-terminal communication. For example, an uplink channel, a downlink channel, and the like may be replaced with a sidelink channel.

Similarly, the user terminal in the present disclosure may be replaced with the base station. In this case, the base station may be configured to include the functions of the user terminal described above.

The term “determining” used in the present disclosure may include various actions or operations. The “determining” may include “judging”, “calculating”, “computing”, “processing”, “deriving”, “investigating”, “looking up, search, inquiry” (for example, looking up a table, database, or other data structures), “ascertaining”, and the like. In addition, “determining” may include “receiving” (for example, receiving information), “transmitting” (for example, transmitting information), “inputting”, “outputting”, “accessing” (for example, accessing data in a memory), and the like. Further, the “determining” may include “resolving”, “selecting”, “choosing”, ““establishing”, “comparing”, and the like. In other words, the “determining” may include “determining” a certain action or operation. Moreover, “determining” may be replaced with “assuming”, “expecting”, “considering”, and the like.

The term “connected” or “coupled” or any variation thereof means any direct or indirect connection or coupling between two or more elements, and may include the presence of one or more intermediate elements between the two elements that are “connected” or “coupled” to each other. The coupling or connection between the elements may be physical, logical, or a combination thereof. For example, “connection” may be replaced with “access”. As used in the present disclosure, the two elements may be regarded as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present disclosure does not mean “based on only” unless otherwise specifically indicated. In other words, the term “based on” includes both “based on only” and “based on at least”.

Any reference to an element using names such as “first” or “second” as used in the present disclosure does not generally limit the amount or the order of the elements. These names may be used in the present disclosure as a convenient way to distinguish two or more elements. Therefore, a reference to the first and second elements does not imply that only two elements may be employed or that the first element must in some way precede the second element.

The term “means” included in the configuration of each of the above apparatuses may be replaced with “parts”, “circuits”, “devices”, and the like.

In the case where the terms “include”, “including” and variations thereof are used in the present disclosure, these terms are intended to be inclusive similar to the term “comprising”. Further, the term “or” used in the present disclosure is not intended to be an “exclusive or”.

A radio frame may be configured by one or more frames in the time domain. Each of the one or more frames in the time domain may be referred to as a sub frame. The sub frame may further include one or more slots in the time domain. The sub frame may have a fixed length of time (for example, 1 ms) independent from numerology.

The numerology may be a communication parameter that is applied to at least one of the transmission or reception of the signal or channel. The numerology may indicate at least one of Sub-Carrier Spacing (SCS), bandwidth, symbol length, cyclic prefix length, Transmission Time Interval (TTI), number of symbols per TTI, radio frame configuration, specific filtering process performed by the transceiver in the frequency domain, specific windowing process performed by the transceiver in the time domain, and the like, for example.

The slot may be configured by one or more symbols in the time domain (Orthogonal Frequency Division Multiplexing (OFDM) symbols, Single Carrier Frequency Division Multiple Access (SC-FDMA) symbols, and the like). The slot may be a time unit based on the numerology.

The slot may include a plurality of mini slots. Each mini slot may be configured by one or more symbols in the time domain. In addition, the mini slot may be referred to as a sub slot. The mini slot may include fewer symbols than the slot. PDSCH (or PUSCH) transmitted in time units greater than the mini slot may be referred to as PDSCH (or PUSCH) mapping type A. The PDSCH (or PUSCH) transmitted using the mini slot may be referred to as PDSCH (or PUSCH) mapping type B.

The radio frame, the sub frame, the slot, the mini slot, and the symbol all represent time units for transmitting signals. Different names may be used for referring to the radio frame, the sub frame, the slot, the mini slot, and the symbol, respectively.

For example, one sub frame may be referred to as a Transmission Time Interval (TTI), multiple consecutive sub frames may be referred to as the TTI, and one slot or one mini slot may be referred to as the TTI. In other words, at least one of the sub frame and the TTI may be a sub frame (1 ms) of an existing LTE, or a period shorter than 1 ms (for example, 1 to 13 symbols), or a period longer than 1 ms. It should be noted that the unit representing the TTI may be referred to as a slot, a mini slot, and the like, rather than a sub frame.

The TTI refers to a minimum time unit for scheduling in the wireless communication, for example. For example, in an LTE system, a base station performs scheduling with respect to each terminal 20 to allocate radio resources (a frequency bandwidth, a transmission power, and the like usable in the terminal 20) in TTI units. The definition of TTI is not limited to the above.

The TTI may be a transmission time unit of channel-encoded data packet (transport block), code block, codeword, and the like, or may be a processing unit of scheduling, link adaptation, and the like. When the TTI is given, a time interval (for example, the number of symbols) during which the transport block, the code block, the codeword, and the like is actually mapped may be shorter than the TTI.

In a case where one slot or one mini slot is referred to as the TTI, one or more TTIs (that is, one or more slots or one or more mini slots) may be a minimum time unit of the scheduling. Further, the number of slots (the number of mini slots) configuring the minimum time unit of the scheduling may be controlled.

The TTI having a time length of 1 ms may be referred to as a normal TTI (a TTI in LTE Rel. 8-12), a general TTI, a long TTI, a general sub frame, a normal sub frame, a long sub frame, a slot, and the like. The TTI that is shorter than the normal TTI may be referred to as a shortened TTI, a short TTI, a partial TTI (or fractional TTI), a shortened sub frame, a short sub frame, a mini slot, a sub slot, a slot, and the like.

The long TTI (for example, the normal TTI, the sub frame, and the like) may be replaced with a TTI having a time length exceeding 1 ms, and the short TTI (for example, shortened TTI and the like) may be replaced with a TTI having a TTI length of 1 ms or longer and shorter than the TTI length of the long TTI.

A Resource Block (RB) is a resource allocation unit of the time domain and the frequency domain, and may include one or more consecutive sub carriers in the frequency domain. The number of sub carriers included in the RB may be the same, regardless of the numerology, and may be 12, for example. The number of sub carriers included in the RB may be determined based on the numerology.

Moreover, the time domain of the RB may include one or more symbols, which may be 1 slot, 1 mini slot, 1 sub frame, or 1 TTI in length. 1 TTI, 1 sub frame, and the like may be configured by one or more resource blocks, respectively.

One or more RBs may be referred to as physical resource blocks (PRBs, Physical RBs), sub carrier groups (SCGs), resource element groups (REGs), PRB pairs, RB pairs, and the like.

Further, the resource block may be configured by one or more Resource Elements (REs). For example, 1 RE may be a radio resource area of 1 sub carrier and 1 symbol. A bandwidth part (BWP) (which may also be referred to as a partial bandwidth and the like) may represent a subset of consecutive common Resource Blocks (common RBs) for a given numerology in a carrier. The common RB may be identified by an index of the RB with reference to a common reference point of the carrier. The PRB may be defined in a BWP, and may be numbered within the BWP.

The BWP may include a BWP for UL (UL BWP) and a BWP for DL (DL BWP). With respect to the terminal 20, one or more BWPs may be configured in one carrier.

At least one of the configured BWPs may be active, and the terminal 20 need not assume transmitting and receiving signals/channels outside the active BWP. The terms “cell”, “carrier”, and the like in this disclosure may be replaced with “BWP”.

Structures of the radio frame, the sub frame, the slot, the mini slot, the symbol, and the like described above are merely examples. For example, the number of sub frames included in the radio frame, the number of slots per sub frame or radio frame, the number of mini slots included in the slot, the number of symbols and RBs included in the slot or mini slot, the number of sub carriers included in the RB, the number of symbols in the TTI, the symbol length, the Cyclic Prefix (CP) length, and the like may be modified in various ways.

In the present disclosure, where an article such as “a”, “an”, or “the” is added by translation, for example, the disclosure may include a noun, following such an article, that is plural.

In the present disclosure, the expression “A and B are different” may mean that “A and B are different from each other”. The expression “A and B are different” may also mean that “A and B are different from C”. Terms such as “separated”, “coupled”, and the like may also be interpreted similarly to the term “different”.

Each aspect/embodiment described in the present disclosure may be used independently, may be used in combination, or may be used by switching according to operations. In addition, indication of predetermined information (for example, notifying “X”) is not limited to an explicit indication, and may be performed by an implicit indication (for example, by not notifying predetermined information).

Although the present disclosure is explained in detail above, it is apparent to a person skilled in the art that the present disclosure is not limited to one or more embodiments of the present disclosure described above. Modifications, variations, and the like of the present disclosure may be made without departing from the subject matter and the scope of the present disclosure defined by the descriptions of claims. Accordingly, the description of the present disclosure is for illustrative purposes only, and is not intended to limit the present disclosure.

### DESCRIPTION OF THE REFERENCE NUMERALS

10: Base station
110: Transmission unit
120: Reception unit
130: Configuration unit
140: Control unit
20: Terminal
210: Transmission unit
220: Reception unit
230: Configuration unit
240: Control unit
1001: Processor
1002: Storage device
1003: Auxiliary storage device
1004: Communication device
1005: Input device
1006: Output device
2001: Vehicle
2002: Drive unit
2003: Steering unit
2004: Accelerator pedal
2005: Brake pedal
2006: Shift lever
2007: Front wheel
2008: Rear wheel
2009: Axle
2010: Electronic control unit
2012: Information service unit
2013: Communication module
2021: Current sensor
2022: Rotation speed sensor
2023: Pneumatic sensor
2024: Vehicle speed sensor
2025: Acceleration sensor
2026: Brake pedal sensor
2027: Shift lever sensor
2028: Object detection sensor
2029: Accelerator pedal sensor
2030: Driving support system unit
2031: Microprocessor
2032: Memory (ROM, RAM)
2033: Communication port (IO port)

1. A terminal comprising:
a communication unit configured to perform transmission and reception of a first Radio Access Technology (RAT); and
a control unit configured to control communication of the first RAT, wherein:
the communication unit receives information related to a resource reservation of a second RAT from an other terminal,
the control unit performs at least one of an operation of determining a resource set of the first RAT available in a physical layer and an operation of selecting a resource from the resource set in a Medium Access Control (MAC) layer, based on the information related to the resource reservation, and
the communication unit performs a transmission to the other terminal using the selected resource.

2. The terminal as claimed in claim 1, wherein the control unit excludes a resource from the resource set based on the information related to the resource reservation of the MAC layer.

3. The terminal as claimed in claim 1, wherein the communication unit reports the information related to the resource reservation to a base station.

4. The terminal as claimed in claim 1, wherein the communication unit transmits a signal for requesting the information related to the resource reservation to the other terminal.

5. The terminal as claimed in claim 1, wherein the control unit determines a preferred resource or a non-preferred resource in an inter-terminal coordination operation, from the information related to the resource reservation.

6. A communication method in which a terminal executes a process comprising:
a communication procedure performing transmission and reception of a first Radio Access Technology (RAT);
a control procedure controlling communication of the first RAT;
a procedure receiving information related to a resource reservation of a second RAT from an other terminal;
a procedure performing at least one of an operation of determining a resource set of the first RAT available in a physical layer and an operation of selecting a resource from the resource set in a Medium Access Control (MAC) layer, based on the information related to the resource reservation, and
a procedure performing a transmission to the other terminal using the selected resource.
